(19) United States
(12) Patent Application Publication
(10) Pub. No.: US 2025/0378454 A1
(43) Pub. Date: Dec. 11, 2025

(54) SYSTEM AND METHOD FOR MANAGING STRUCTURED DATASETS

(71) Applicant: CAMBRIAN LABS LLC, Berkeley, CA (US)

(72) Inventors: Manu Kalia, San Francisco, CA (US); Olaf Jonny Groth, Berkeley, CA (US); Tobias Christopher Straube, Hamburg (DE); Michael Jeffrey, Orinda, CA (US); Mark Jay Nitzberg, Berkeley, CA (US)

(73) Assignee: CAMBRIAN LABS LLC, Berkeley, CA (US)

(21) Appl. No.: 19/227,733

(22) Filed: Jun. 4, 2025

Related U.S. Application Data
(60) Provisional application No. 63/657,554, filed on Jun. 7, 2024.

(51) Int. Cl. G06Q 30/0201; G06Q 30/018; G06Q 30/0204

(52) U.S. Cl. CPC G06Q 30/02011; G06Q 30/018; G06Q 30/0204

(57) ABSTRACT

An automated integrated dataset marketplace method is disclosed. The method includes capturing and processing user data from transactions associated with a user to generate a user data footprint. The method includes creating reference clusters from the captured user data, identifying, confirming, and rating provenance characteristics of the user data in the created reference clusters. The method includes generating an augmented user data footprint through supplemental user data, including watermark and authorization data on a territory basis, and processing the augmented user data footprint, scoring the same based on industry-specific parameters and weightings, and generating one or more user data registries on an industry-by-industry basis. Thereafter, the method includes enabling transacting of datasets from the one or more user data registries between users supplying data for said datasets and entities desiring to acquire the same.

### CROSS-REFERENCE TO RELATED APPLICATIONS

This application is related to and claims priority to U.S. Provisional Application No. 63/657,554 filed on Jun. 7, 2024, and titled “User Footprint PIDA Scores & Registry IP”, which is hereby incorporated by reference in its entirety.

### TECHNICAL FIELD

The present invention relates to systems and methods for creating customized structured data sets, including variants that are scored by and for particular industries to facilitate the creation of markets in such assets.

### DESCRIPTION OF THE RELATED ART

In the current landscape of online advertising, personal data is predominantly controlled by major data collection entities. Such entities aggregate, segment, and classify user data into distinct audience groups based on demographics, interests, and behavioral patterns using well-established methodologies. Advertisers leverage these classifications to target custom audiences through various delivery channels, including search engines, applications, and other digital platforms. Within this framework, an individual's personal data is monetized by third-party platforms, primarily for the delivery of advertising content aimed at driving consumer purchases. However, individuals themselves have little control over use of their data, and derive little to no direct financial benefit from such use, despite its instrumental role in enabling targeted advertising. This lack of control and revenue-sharing discourages individuals from voluntarily disclosing their private and high-value data, particularly sensitive data related to health conditions, medical treatments, and personal consumption behaviors.

Despite the significant potential value of this data to industries such as healthcare, pharmaceuticals, and artificial intelligence, individuals remain reluctant to share their information due to privacy concerns, lack of transparency, and the risk of unauthorized data usage. In the pharmaceutical industry, for instance, access to real-world patient data, including medical diagnoses, treatment regimens, and behavioral health indicators, is crucial for the development of new drug formulations, identification of clinical trial candidates, and assessment of therapeutic effectiveness. Similarly, in the AI sector, machine learning models rely heavily on diverse, high-quality datasets for accurate training and refinement. Rich and diverse datasets improve the performance of AI systems and rate of development of key products such as pharmaceutical. The absence of willing user participation in data sharing therefore directly restricts advancements in both fields, impeding the development of AI-driven solutions and delaying pharmaceutical innovation.

Even if individuals would be willing to share their data in exchange for fair compensation, they often lack confidence in the security and governance mechanisms that regulate data usage. Concerns over unauthorized exploitation, improper data handling, and inadequate privacy safeguards prevent them from engaging in direct data-sharing transactions. Recent advancements, such as those described in U.S. Pat. No. 11,899,760 to Cambrian (incorporated by reference herein), introduce privacy charters, selective watermarking, and transparent data governance frameworks to ensure equitable treatment and protection of individual data. However, existing platforms still lack a comprehensive marketplace model that effectively incentivizes and rewards users for controlled, transparent, and privacy-compliant data sharing.

Thus, there remains a strong current need for a mechanism and platform that induces and rewards individuals for sharing high-quality data, as this data procurement has a significant knock-on effect: among other benefits, it improves the speed of development and efficacy of new drug formulations, as well as improving training of computing systems for AI applications and the quality of their outputs.

### BRIEF SUMMARY

An object of the present invention(s), therefore, is to reduce and/or overcome the limitations of the prior art, and to create new types of data markets that are valuable to commercial entities and fair to the providers of such data. In an embodiment, the present disclosure utilizes Privacy-Inclusive Data Access (PIDA) scores to enable trust-based, granular, and industry-specific dataset transactions. The PIDA scores may comprise multiple components, including, but not limited to, a Footprint Score reflecting the availability of dataset attributes, and an Attribute Value Score reflecting the specific values of those attributes. In practical deployment, it is the data buyer, typically an industry participant, who applies customized weights to these components based on the relative importance of specific attributes or dimensions for their sector. For instance, a pharmaceutical company may heavily weigh medical history and biometric data, while an e-retailer may emphasize demographic and transactional information. These buyer-specific weightings play a key role in the final PIDA scoring outcome and are captured and stored by the system as part of the data scoring and exchange process.

One or more embodiments are directed to an automated integrated dataset marketplace system and method (hereinafter may also be termed “mechanism”) for enabling secure, privacy-compliant, and provenance-validated data transactions. The disclosed mechanism facilitates the collection, structuring, scoring, and exchange of datasets while ensuring industry relevance and regulatory compliance.

In an embodiment, the disclosed mechanism captures user data from multiple sources, such as e-commerce transactions, medical visits, online activity, social interactions, and biometric data. The collected data is processed to create structured reference clusters, allowing for efficient categorization and analysis. The structured reference clusters are evaluated to determine provenance, ensuring authenticity, origin verification, and compliance with industry standards. In an embodiment, the disclosed mechanism enhances the user data footprint by embedding watermarks and jurisdiction-based authorization data to enforce regulatory compliance and prevent unauthorized data use. To assess the quality and industry relevance of the structured dataset, Privacy-Inclusive Data Access (PIDA) scoring is applied, dynamically adjusting based on user privacy preferences and industry-specific demand.

In an embodiment, the disclosed mechanism allows users to define privacy charters, specifying the attributes they choose to share and the conditions under which they can be accessed. Transactions within the disclosed mechanism undergo compliance verification, ensuring that potential data buyers meet privacy regulations, industry standards, and ethical AI guidelines before gaining access to datasets. Further, the disclosed mechanism supports multi-party transactions, enabling multiple buyers to access segmented portions of a dataset based on customized access permissions. In an embodiment, the disclosed mechanism automates compensation for data transactions through smart contracts, tokenized payments, or royalty-based models, ensuring fair and transparent remuneration for data providers. Additionally, blockchain-based verification can be integrated to maintain an immutable record of data transactions, reinforcing trust and accountability. In an embodiment, AI-driven predictive models optimize dataset valuation, demand forecasting, and transactional recommendations based on industry trends. Further, the disclosed mechanism employs differential privacy techniques to protect individual identities while enabling large-scale data analytics.

An embodiment of the present disclosure discloses the automated integrated dataset marketplace system. The modules of the automated integrated dataset marketplace system can be seen as effectuating multiple layers of a unified system that extends from a single datapoint taken from a single transaction with a single user, to large bundled datasets spanning multiple data types for millions of users. In one embodiment, the system includes a data acquisition module to capture and process user data from various transactions associated with a user to generate a user data footprint. The data acquisition module is adapted to collect user data from one or more sources. The sources include e-commerce transactions, medical visits, online activity, social interactions, and/or biometric data. In some embodiments, the data acquisition module applies data encryption and anonymization techniques to ensure user privacy and compliance with regulatory requirements.

In an embodiment, the system includes a data clustering module adapted to create reference clusters from the captured user data. In an embodiment, the data clustering module utilizes machine learning algorithm(s) selected from a group consisting of unsupervised clustering and/or Natural Language Processing (NLP) to process the user data and generate structured clusters. In certain implementations, the data clustering module groups user data attributes into industry-specific categories. The industry-specific categories include healthcare, financial transactions, artificial intelligence, and/or consumer behavior analytics. In some embodiments, the same cluster or bundle of user data may be relevant to multiple industries, each with different scoring priorities and data valuation models. For instance, a micro-credit scoring dataset, containing employment history, mobile payment records, and device metadata, may be useful in financial services, mobile commerce, or public sector subsidy programs. In such cases, the system may assign multiple Footprint PIDA scores to the same data bundle, with each score corresponding to a specific buyer exploitation profile or industry use case.

In an embodiment, the system includes a provenance module adapted to identify, confirm, and rate provenance characteristics of the user data in the created reference clusters. In some implementations, the provenance module assigns a provenance trust score to each dataset by analyzing the origin, authenticity, and verification status of the user data. In an embodiment, the provenance module employs blockchain-based verification to ensure data integrity and track the history of user data transactions. In some embodiments, the system includes a metadata augmentation module adapted to generate an augmented user data footprint by supplementing the collected user data with additional metadata, watermarks, and authorization data on a territory basis. In certain implementations, the metadata augmentation module generates watermarked datasets to uniquely identify data ownership and detect unauthorized distribution. In an embodiment, the metadata augmentation module embeds territory-based authorizations within the dataset to ensure jurisdictional compliance for data transactions.

In an embodiment, the system includes a data scoring module adapted to process the augmented user data footprint, evaluate the dataset based on industry-specific parameters and weightings, and generate one or more user data registries on an industry-by-industry basis. In some implementations, the data scoring module applies Privacy-Inclusive Data Access (PIDA) scoring to assess the quality and industry relevance of user datasets, considering factors such as privacy settings, completeness, and usability. In an embodiment, the data scoring module dynamically adjusts the PIDA score based on user privacy preferences and industry demand for specific data attributes.

In an embodiment, the system includes a marketplace creator exchange module adapted to enable transactions of datasets from one or more user data registries. The datasets are transacted between users supplying data and entities desiring to acquire the same. In some implementations, the marketplace creator exchange module enables users to define customized privacy charters, allowing them to selectively share data attributes based on industry type and buyer reputation. In an embodiment, the marketplace creator exchange module provides automated compensation mechanisms. The mechanisms may include smart contracts, tokenized payments, or royalty-based transactions, ensuring that users sharing high-value data footprints receive fair compensation. In an embodiment, the marketplace creator exchange module includes compliance verification tools, which assess potential data buyers against privacy regulations, industry standards, and ethical AI practices before approving data transactions. In some implementations, the marketplace creator exchange module supports multi-party data transactions. The multiple buyers are allowed to access segmented portions of the dataset based on customized access permissions.

An embodiment of the present disclosure discloses the automated integrated dataset marketplace method. The method includes the steps of capturing and processing user data from transactions associated with a user to generate a user data footprint. The method ensures that user data is systematically collected, analyzed, and structured for further processing. In an embodiment, the method includes the steps of creating reference clusters from the captured user data. The method includes applying computational techniques to categorize user data into meaningful groups, facilitating improved organization and accessibility of data for industry-specific applications. In an embodiment, the method also includes the steps of identifying, confirming, and rating provenance characteristics of the user data in the created reference clusters. Further, the method includes ensuring that each dataset undergoes provenance verification, allowing assessment of data authenticity, origin, and reliability before it is processed.

In an embodiment, the method includes the steps of generating an augmented user data footprint through supplemental user data. The supplemental user data incorporates watermarking and authorization data on a territory basis. This ensures that datasets contain secure, traceable identifiers that comply with jurisdictional regulations and enable ownership tracking. In an embodiment, the method includes the steps of processing the augmented user data footprint, scoring the dataset based on industry-specific parameters and weightings, and generating one or more user data registries on an industry-by-industry basis. Further, the method includes ensuring that datasets are evaluated against sector-specific benchmarks to enhance their usability across different industries.

In an embodiment, the method includes the steps of enabling transacting of datasets from the one or more user data registries, wherein data suppliers and acquiring entities participate in a secure marketplace. The method includes controlling access to datasets while allowing secure, structured transactions based on industry requirements. In an embodiment, the method includes the steps of collecting user data from one or more sources, wherein the sources may include at least one of e-commerce transactions, medical visits, online activity, social interactions, and biometric data. In an embodiment, the method includes applying data encryption and anonymization techniques to ensure that collected user data remains secure and privacy-compliant. In an embodiment, the method includes the steps of utilizing machine learning algorithms, including unsupervised clustering and Natural Language Processing (NLP), to create reference clusters from user data. In an embodiment, the method includes ensuring that user data attributes are grouped into industry-specific categories. The categories include healthcare, financial transactions, artificial intelligence, and/or consumer behavior analytics.

In an embodiment, the method includes the steps of assigning a provenance trust score to each dataset by analyzing the origin, authenticity, and verification status of the user data. In an embodiment, the method includes blockchain-based verification to maintain data integrity and track the historical usage of the dataset. In an embodiment, the method includes the steps of generating watermarked datasets to uniquely identify data ownership and detect unauthorized distribution. Further, the method includes embedding territory-based authorizations within the dataset, ensuring jurisdictional compliance with regional regulations governing data transactions. In an embodiment, the method includes the steps of applying Privacy-Inclusive Data Access (PIDA) scoring to evaluate the quality and industry relevance of user datasets. Further, the method includes adjusting the PIDA score dynamically based on user privacy preferences and industry demand for specific data attributes, ensuring that data valuation remains adaptable to evolving market requirements.

Another aspect of the disclosure concerns methods of generating valuations of user data, on an entity and industry basis. The method includes the steps of generating a first data footprint for a first user, including first data attributes and first associated data attribute values. Further, the method includes deriving a first coverage value for said first data footprint based on a first number of said data attributes associated with said first user. In an embodiment, the method includes deriving a second attribute-related value for said first data footprint based on data attribute values for said first user's data attributes. Further, the method includes deriving a first data footprint value for said first data footprint based on said first coverage value, said second attribute-related value, and a number of said data attributes made available by the first user to said first industry.

A further aspect of the disclosure is directed to methods and systems for generating a valuation of user data for a first digital service provider (DSP). In this process, automated embodiments generally perform the steps of analyzing content in a DSP privacy policy and/or data use agreement to derive first DSP-specific scores to first user data attributes and second DSP specific-scores to attribute values associated with said first user data attributes. Further, the automated embodiments perform the steps of processing data in a user observation footprint registry to generate a first DSP coverage score for a first user data footprint based on a first number of said data attributes made available by a first user. In an embodiment, the automated embodiments perform the steps of processing data in a user transformed footprint registry to generate a second DSP attribute score for said first user data footprint based on attribute values determined by a clustering algorithm for said first number of said data attributes made available by a first user. Moreover, the automated embodiments perform the steps of generating a third DSP compliance score for said first user data footprint based on privacy settings provided in a privacy charter for said first user; and generating a composite score representing a DSP valuation of said first user data footprint based on the scores determined in step (b) through (d). In these user data valuations or scoring, the user transformed footprint registry is generated by combining said user observation footprint registry with transactional data for said user. The user transformed footprint registry may be created by combining the user observation footprint registry with transactional data for the user. The first user data footprint can be presented in a data marketplace along with the composite score.

Still another aspect of the disclosure concerns methods of creating marketable user data sets for a first industry comprising generally the steps of: processing first user footprint data originating from observations of a first user to identify first data attributes and first attribute values associated with said first data attributes for said user; normalizing the first user footprint and storing it in a data footprint database; generating a first user value score for said first user; specifying a first industry-specific attribute weight said first data attributes and a second industry-specific attribute value weight for said first attribute values; and generating a first industry-specific value score for said first user based on said first user value score and said first industry-specific attribute weight and said second industry-specific attribute value weight. This particular method can further include a step of filtering the first user footprint data based on a privacy charter associated with the user before generating said first industry-specific value score. In addition, fingerprint data can be created for the first user footprint. The fingerprint data is derived from features identified on an industry-by-industry basis. In some instances, an additional step of generating watermark data for the first user footprint is performed to facilitate identification of the first user data. The watermark data may be embedded and combined with user footprint data and configured such that removal of such watermark causes degradation of the underlying user footprint data. In other instances, the watermark data is configured to be detected in outputs of a large language model-based AI system with a predetermined confidence level. For some applications, watermark data is derived from the first user data footprint data, and additional private data related to the user is added to enhance a fidelity characteristic of the watermark, including in encoding and/or decoding. In response to a query, the automated method selects a subset of user data footprints customized for a specific industry. Additional steps in the process may include: creating enhanced data from fingerprinting and/or watermarking the first user footprint; and storing the enhanced data in a data registry along with user identification information. Additional watermark data can be generated for the user footprint data, which can be derived from transactional data for the first user. The user's user footprint data can be supplemented with metadata and stored with combined data in a registry. In some industries, the user footprint data is processed to put it into a form suitable for use by a large language model (LLM).

The features and advantages of the subject matter here will become more apparent in light of the following detailed description of selected embodiments, as illustrated in the accompanying FIGUREs. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates a block diagram of a dataset marketplace system, in accordance with an embodiment of the present disclosure.

FIG. 2 is a flow diagram illustrating processes employed by a data acquisition module as part of supporting the dataset marketplace system, in accordance with an embodiment of the present disclosure.

FIG. 3A is a flow diagram illustrating processes employed by a user data clustering module as part of supporting the dataset marketplace system, in accordance with an embodiment of the present disclosure.

FIG. 3B is a flow diagram illustrating processes employed by an industry data clustering module as part of supporting the dataset marketplace system, in accordance with an embodiment of the present disclosure.

FIG. 4 is a flow diagram describing processes performed by a provenance module, in accordance with an embodiment of the present disclosure.

FIG. 5 is a flow diagram describing processes performed by a metadata augmentation module, in accordance with an embodiment of the present disclosure.

FIG. 6 is a flow diagram describing processes performed by a dataset scoring module, in accordance with an embodiment of the present disclosure.

FIG. 7 is a flow diagram describing processes performed by a marketplace creator exchange module, in accordance with an embodiment of the present disclosure.

FIGS. 8A-8D are examples of interfaces of a marketplace adapted to enable transacting of datasets, in accordance with an embodiment of the present disclosure.

FIG. 9 is a flow chart of a dataset marketplace method, in accordance with an embodiment of the present disclosure.

FIG. 10 illustrates an exemplary computer unit in which or with which embodiments of the present disclosure may be utilized.

Other features of embodiments of the present disclosure will be apparent from accompanying drawings and detailed description that follows.

### DETAILED DESCRIPTION

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Embodiments of the present disclosure may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, magnetic tape, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other types of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within the single computer) and storage systems containing or having network access to a computer program(s) coded in accordance with various methods described herein, and the method steps of the disclosure could be accomplished by modules, routines, subroutines, or subparts of a computer program product.

### Terminology

Brief definitions of terms used throughout this application are given below.

The terms “connected” or “coupled”, and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software configured to perform such functions. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

One or more embodiments are directed to an automated integrated dataset marketplace system and method (hereinafter may also be termed “mechanism”) for enabling secure, privacy-compliant, and provenance-validated data transactions. The disclosed mechanism facilitates the collection, structuring, scoring, and exchange of datasets while ensuring industry relevance and regulatory compliance.

In an embodiment, the disclosed mechanism captures user data from multiple sources, including from e-commerce transactions, medical visits, online activity, social interactions, and biometric data. It will be understood by those skilled in the art that other sources can be used as well. The collected data is processed to create structured reference clusters, allowing for efficient categorization and analysis. These clusters are further evaluated to determine provenance, ensuring authenticity, origin verification, and compliance with industry standards. In an embodiment, the disclosed mechanism enhances a user data footprint by embedding watermarks and jurisdiction-based authorization data to enforce regulatory compliance and prevent unauthorized data use. To assess the quality and industry relevance of the structured dataset, a customizable Privacy-Inclusive Data Access (PIDA) scoring is applied, dynamically adjusting based on user privacy preferences and industry-specific demand.

In an embodiment, the disclosed mechanism allows users to define customized privacy charters, specifying the attributes they choose to share and the conditions under which they can be accessed. Transactions within the disclosed mechanism undergo compliance verification, ensuring that potential data buyers meet privacy regulations, industry standards, and ethical AI guidelines before gaining access to datasets. The disclosed mechanism also supports multi-party transactions, enabling multiple buyers to access segmented portions of a dataset based on customized access permissions. In an embodiment, the disclosed mechanism automates compensation for data transactions through smart contracts, tokenized payments, or royalty-based models, ensuring fair and transparent remuneration for data providers. Additionally, blockchain-based verification can be integrated to maintain an immutable record of data transactions, reinforcing trust and accountability. In an embodiment, AI-driven predictive models optimize dataset valuation, demand forecasting, and transactional recommendations based on industry trends. The disclosed mechanism also employs differential privacy techniques to protect individual identities while enabling large-scale data analytics.

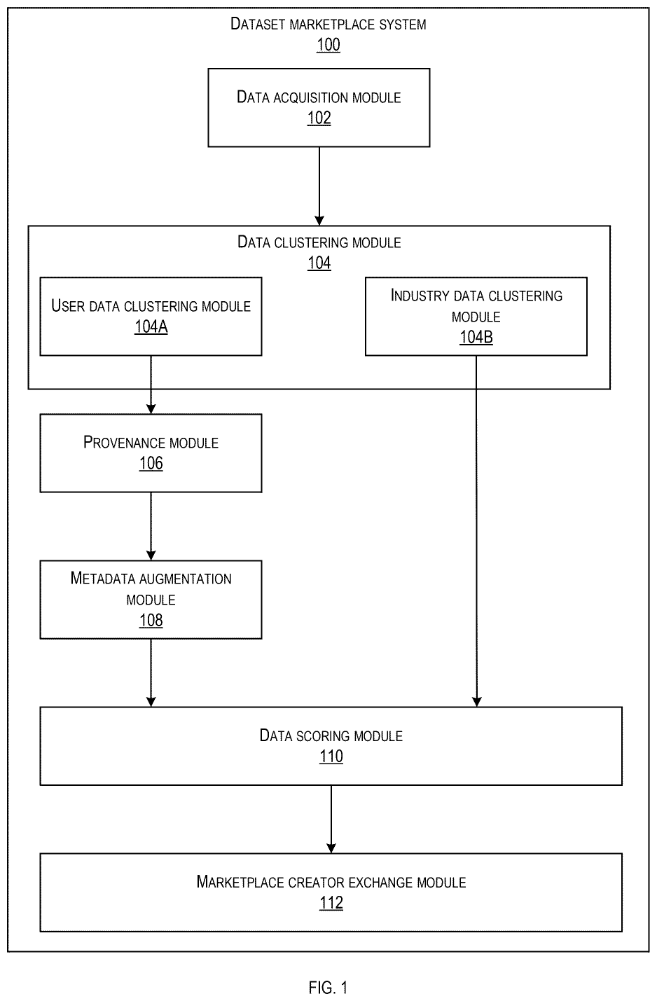

FIG. 1 illustrates a block diagram of a dataset marketplace system 100, in accordance with an embodiment of the present disclosure. The dataset marketplace system 100 (hereinafter may also be termed as an automated integrated dataset marketplace system 100 or a system 100) may be a structured, privacy-compliant, and provenance-validated platform for the acquisition, processing, scoring, and exchange of structured datasets. The system 100 may facilitate data providers, enterprises, researchers, and AI developers to transact individual and/or collections of data footprints in a secure and transparent manner while ensuring compliance with privacy regulations and industry-specific requirements. Further, the system 100 may facilitate structured data transactions by integrating mechanisms for provenance verification, metadata augmentation, data scoring, and controlled exchange, making the system 100 suitable for various digital ecosystems where data is collected, analyzed, and monetized.

In an embodiment, the dataset marketplace system 100 may be implemented in enterprise data platforms, where organizations may integrate the system 100 into corporate data management frameworks to structure, validate, and monetize datasets. Further, the system 100 may be applicable to AI and machine learning training pipelines, providing AI models with privacy-compliant and provenance-verified training datasets. In the healthcare and pharmaceutical industries, the system 100 may enable the secure exchange of medical datasets, supporting AI-driven diagnostics, clinical trials, and personalized medicine development while maintaining territorial authorization for compliance with regulations such as HIPAA (U.S.), GDPR (EU), and PDPA (Asia-Pacific). Additionally, the system 100 may facilitate data transactions in the e-commerce and consumer analytics sectors, allowing retailers, advertisers, and financial institutions to access structured datasets on consumer behavior, transaction patterns, and market trends while ensuring ethical and privacy-conscious data utilization. In an embodiment, government and regulatory agencies may leverage the system 100 for policy-making, fraud detection, and cybersecurity, ensuring datasets are sourced from verified and trusted origins.

In an embodiment, as a computing-based infrastructure, the dataset marketplace system 100 may serve as an intermediary between data providers and data consumers, applying privacy constraints, provenance verification, and industry-specific scoring before dataset transactions occur. The system 100 may function as a fully decentralized data exchange, a centralized model, or a hybrid system, depending on industry-specific needs and regulatory requirements. The system 100 may support privacy-first data monetization by allowing users to define data-sharing preferences, apply access controls, and receive compensation through tokenized transactions. The system 100 may facilitate provenance verification by validating datasets using blockchain or digital signatures, preventing fraudulent or low-trust data sources. The system 100 may categorize datasets into customized industry verticals such as healthcare, AI, and financial markets, enhancing their usability. Further, the system 100 may embed territory-based authorization metadata to ensure compliance with regional data protection laws and utilizes Privacy-Inclusive Data Access (PIDA) scoring to dynamically assign value to datasets based on their completeness, accuracy, and industry demand.

In an embodiment, the dataset marketplace system 100 may include integration with federated learning. Such integration facilitates AI models to be trained on decentralized data without exposing raw datasets. The system 100 may also expand into Web3 and decentralized data markets, supporting blockchain-based smart contracts for automated and trustless data transactions. In an embodiment, the system 100 may evolve to support multi-modal data processing, extending beyond text-based datasets to include images, videos, IoT data streams, and genomic datasets. Cross-industry collaboration frameworks can also be integrated to facilitate secure, controlled data sharing between enterprises for research and innovation.

In an embodiment, the system 100 may include a data acquisition module 102, a data clustering module 104, a provenance module 106, a metadata augmentation module 108, a data scoring module 110, and a marketplace creator exchange module 112. The data acquisition module 102, the data clustering module 104, the provenance module 106, the metadata augmentation module 108, the data scoring module 110, and the marketplace creator exchange module 112 may be communicatively coupled to a memory and a processor of the system 100. The processor may be configured to control the operations of the data acquisition module 102, the data clustering module 104, the provenance module 106, the metadata augmentation module 108, the data scoring module 110, and the marketplace creator exchange module 112. In an embodiment of the present invention, the processor and the memory may form a part of a chipset and/or system on a chip (SOC) installed in the system 100. In another embodiment of the present invention, the memory may be implemented as a static memory or a dynamic memory. In an example, the memory may be internal to the system 100, such as an onside-based storage. In another example, the memory may be external to the system 100, such as cloud-based storage. Further, the processor may be implemented as one or more microprocessors microcomputers, microcomputers, digital signal processors, central processing units, state machines, logic circuitries, and/or any devices that manipulate signals based on operational instructions.

In an embodiment, the data acquisition module 102 may capture and process user data from transactions associated with a user to generate a unique user data footprint. The data acquisition module 102 may collect user data from one or more sources. The sources may include e-commerce transactions, medical visits, online activity, social interactions, and/or biometric data. In an embodiment, the data acquisition module 102 may apply data encryption and anonymization techniques to ensure user privacy and compliance with regulatory requirements. Further, the data acquisition module 102 may serve as the entry point of the dataset marketplace system 100 and enables automated and real-time data collection, ensuring that user-generated datasets remain accurate, up-to-date, and structured.

In an embodiment, the data acquisition module 102 may collect transactional, behavioral, and biometric datasets from multiple sources. The data acquisition module 102 may be integrated with enterprise data platforms, consumer-facing applications, third-party data aggregators, IoT devices, and real-time data streams to acquire relevant datasets. For example, in the context of e-commerce transactions, the data acquisition module 102 may retrieve purchase history, browsing patterns, cart data, and payment records from online marketplaces. In a medical and healthcare setting, the data acquisition module 102 may acquire electronic health records (EHRs), prescription histories, and wearable device data to support clinical research and AI-driven diagnostics. Similarly, for online activity and social interactions, the data acquisition module 102 may process search queries, website visits, social media interactions, and digital content consumption to create structured user profiles. In an embodiment, the data acquisition module 102 may collect biometric and sensor data. The biometric and sensor data may include fingerprints, facial recognition patterns, heart rate, motion tracking, and fitness tracker logs from connected devices. Other sources of user data suitable for the present embodiments will be apparent to skilled artisans.

In an embodiment, the data acquisition module 102 may ensure that the collected data is handled securely while complying with data privacy laws and regulatory standards. The data acquisition module 102 may incorporate encryption mechanisms such as AES-256 or RSA encryption to secure user data during transmission and storage. In some implementations, the data acquisition module 102 may apply data anonymization techniques, including k-anonymity, differential privacy, and homomorphic encryption, to prevent unauthorized identification of individual users. Further, the data acquisition module 102 may enforce user consent frameworks, ensuring that data collection is conducted with explicit user permission in compliance with regulations such as GDPR, HIPAA, and CCPA. In an embodiment, the data acquisition module 102 may be implemented as a scalable cloud-based infrastructure that supports both batch and real-time data ingestion. In some implementations, the data acquisition module 102 may utilize batch processing pipelines based on Apache Hadoop or Google BigQuery to handle large-scale data collection from enterprise sources. In some embodiments, the data acquisition module 102 may employ real-time streaming technologies such as Apache Kafka, AWS Kinesis, or Google Pub/Sub to capture high-frequency data updates. In API-driven environments, the data acquisition module 102 may integrate with RESTful or GraphQL APIs to facilitate structured data retrieval from external sources. Further, the data acquisition module 102 may implement federated learning techniques for decentralized data acquisition, allowing edge devices to contribute data without exposing raw user information.

In an embodiment, the data acquisition module 102 may enforce access control mechanisms and data governance policies to prevent unauthorized access and misuse of user data. Further, the data acquisition module 102 may implement role-based access control (RBAC), multi-factor authentication (MFA), and blockchain-based audit trails to enhance security and ensure data traceability. In an embodiment, the data acquisition module 102 may deploy zero-trust security frameworks in high-security environments, to ensure that every data access request is verified and authenticated before granting permissions. In an embodiment, the data clustering module 104 may create distinct, customized individual reference clusters from the captured user data. In an embodiment, the data clustering module 104 may utilize machine learning algorithm(s) selected from a group consisting of unsupervised clustering and Natural Language Processing (NLP) to create reference clusters from user data. In some implementations, the data clustering module 104 may group user data attributes into a set of industry-specific categories. The categories may include healthcare, financial transactions, artificial intelligence, and consumer behavior analytics to name a few. In an embodiment, the data clustering module 104 may structure the acquired datasets to facilitate a categorization process creating user-specific and industry-relevant clusters. The clustering process may ensure that data is logically segmented based on patterns, similarities, and industry needs, thereby enhancing usability, searchability, and market relevance. In an embodiment, the data clustering module 104 may include two sub-modules: a user data clustering module 104A and an industry data clustering module 104B, each performing distinctly specialized functions within the system 100.

In an embodiment, the user data clustering module 104A may organize raw user data into a set of structured reference clusters. The user data clustering module 104A may apply machine learning algorithms, including unsupervised clustering and NLP, to detect patterns in user-generated data and categorize the generated data into useful, meaningful and optimized segments. The clustering process may leverage techniques such as K-means clustering, hierarchical clustering, density-based clustering (DBSCAN), or self-organizing maps (SOMs) to identify relationships within user datasets. In some embodiments, the user data clustering module 104A may process individual user behaviors, preferences, and transaction histories to generate personalized data clusters. For example, in an e-commerce environment, the user data clustering module 104A may group user data based on purchasing patterns, product preferences, spending behavior, and other measurable user behavioral activities known in the art. In healthcare applications, the module may categorize user data into clusters such as chronic disease records, fitness levels, or prescription adherence patterns. Similarly, for financial transactions, the user data clustering module 104A may segment users into clusters such as high-frequency traders, long-term investors, credit risk categories, and other groupings known in the art. Further, the user data clustering module 104A may enable and effectuate privacy-preserving clustering, ensuring that sensitive user data is pseudonymized or anonymized before clustering. In some implementations, the user data clustering module 104A may apply federated learning techniques to allow clustering across multiple decentralized datasets without exposing raw user data.

In an embodiment, the industry data clustering module 104B may group datasets based on industry-specific attributes and parameters. The industry data clustering module 104B may align dataset structures with a set of industry taxonomies, allowing businesses and organizations to access pre-clustered datasets customized and optimized for specific domains. In some implementations, the industry data clustering module 104B may categorize datasets into a set of industry-specific categories. The set of categories may, without any limitation, include healthcare, financial transactions, artificial intelligence, consumer behavior analytics, navigation, transportation, dining, entertainment across all media (music, film, streaming video, podcasts, video gaming, etc.), gambling, hospitality, fashion, social media, real estate, manufacturing, telecommunications, mining, oil and gas, electric utilities, logistics and supply chain, consumer packaged goods, education, and government. Other categories of course may be implemented in accordance with the present teachings. The clustering process may ensure that datasets are structured according to industry best practices, making them readily usable by AI models, analytics platforms, and business intelligence systems. For example, in a healthcare setting, the industry data clustering module 104B may structure datasets into electronic health records (EHRs), clinical trial data, diagnostic imaging data, and pharmaceutical sales trends. In financial services, the industry data clustering module 104B may classify datasets into credit risk profiles, fraud detection patterns, stock market transaction logs, and customer spending habits. Similarly, in artificial intelligence applications, the industry data clustering module 104B may organize datasets into one or more labeled training sets, synthetic data generation clusters, and reinforcement learning environments.

In an embodiment, the provenance module 106 may identify, confirm, and rate a set of provenance characteristics of the user data in the created reference clusters. In some embodiments, the provenance module 106 may assign a customizable provenance trust score to each dataset by analyzing origin, authenticity, and verification status parameters associated with the user data. The provenance module 106 may employ blockchain-based verification to ensure data integrity and track the history of user data transactions. In an embodiment, the provenance module 106 may ensure that every dataset processed within the dataset marketplace system 100 includes associated verifiable origin data, an immutable transaction history, and a dynamic trust rating to reduce and/or prevent the use of fraudulent or unreliable data. In an embodiment, the provenance module 106 may assign a customized provenance trust score to each dataset by evaluating multiple parameters. Such parameters may include data source reliability factors. The data source reliability may determine whether the data originates from a verified institution, trusted IoT device, or reputable data provider. Further, the provenance module 106 may perform a consistency and redundancy check by comparing datasets with existing entries in the provenance repository to identify and reduce potential duplications or anomalies. In an embodiment, the provenance module 106 may facilitate timestamp and origin validation parameters, verifying that the dataset carries an immutable timestamp and geolocation metadata that reflects its actual point of creation. Moreover, the provenance module 106 may perform user or device-level validation, confirming that the dataset was collected from an authenticated user account, verified biometric sensor, or enterprise system. In some embodiments, the provenance trust score is dynamically updated based on real-time validation events, ensuring datasets retain accurate trust ratings throughout their lifecycle.

In an embodiment, the provenance module 106 may employ blockchain-based verification to ensure that datasets remain tamper-proof and traceable. The provenance module 106 may integrate with permissionless, permissioned and/or public blockchain ledgers to create immutable provenance records for each dataset. In one implementation, the provenance module 106 may generate a unique cryptographic hash for each dataset and store the cryptographic hash on a blockchain ledger. Such storing may facilitate future verifications to confirm that a dataset remains unaltered from its original state. In some implementations, the provenance module 106 may assign one or more digital tokens or cryptographic signatures to datasets, allowing buyers and data consumers to verify dataset authenticity before engaging in transactions. Further, the provenance module 106 may utilize blockchain smart contracts to automatically enforce provenance checks before datasets are added to the marketplace exchange. In yet another embodiment, the provenance module 106 may assign configurable provenance tags to datasets, ensuring that each data footprint carries an associated corresponding audit trail of its origin, transformations, and access history. The provenance-tagging process may include generating a provenance tag based on data source, timestamps, and verification attributes. In an embodiment, the system 100 may execute a validation service, cross-referencing the provenance tags with reference datasets to ensure their authenticity. Once validated, the dataset may be added to a provenance-scored repository, allowing future marketplace participants to access and consult the dataset's trust rating before initiating transactions.

In an embodiment, the provenance module 106 may incorporate selective watermarking mechanisms not only for post-validation traceability but also as part of the provenance determination process itself. For example, the presence, structure, or metadata embedded within a watermark may serve as a signal or input during the computation of a dataset's provenance trust score. In certain implementations, a selective watermark may encode a set of source identifiers, timestamps, jurisdictional tags, or data generation history, which can be parsed and verified to establish the origin, authenticity, or permitted lineage of a dataset. The selective watermark may facilitate an alternative or supplementary method of validating provenance; wherein trusted watermark issuance may substitute or reinforce traditional methods like source assertion tokens or blockchain-based verification trails.

In an embodiment, the provenance module 106 may ensure compliance with a set of data governance and regulatory frameworks and specific requirements by maintaining an immutable log of data transactions and origin details. The provenance module 106 may support compliance with regulations such as the General Data Protection Regulation (GDPR) by ensuring that users retain the right to be forgotten and data traceability, the Health Insurance Portability and Accountability Act (HIPAA) by verifying data security and integrity in healthcare transactions, and the California Consumer Privacy Act (CCPA) by ensuring that datasets are processed in alignment with consumer privacy rights. Further, the provenance module 106 may integrate with and consult territory-based authorization mechanisms to ensure that datasets originating from specific jurisdictions are only made available in compliance with local laws. In an embodiment, the provenance module 106 may facilitate multi-party verification and trust-based access control by enabling third-party verification agencies, compliance auditors, and independent reviewers to validate dataset provenance before it is made available in the marketplace exchange. In some implementations, the provenance module 106 may support hierarchical trust scoring, wherein datasets from high-trust sources (e.g., verified medical institutions, and enterprise research labs) receive higher provenance scores compared to datasets from lower-trust sources. In some embodiments, the provenance module 106 may operate independently of watermarking mechanisms. That is, watermarking may not be required as a precondition for establishing the provenance of user datasets, which may be determined through other mechanisms, including, but not limited to, source assertion tokens, creator footprint repositories, cryptographic identifiers, and trust score aggregations derived from verified data channels. In such cases, watermarking may be applied selectively after provenance has already been validated, primarily for purposes of traceability, ownership enforcement, and transactional monitoring. Accordingly, the system 100 may accommodate datasets that were ingested without embedded watermarks, while still preserving robust provenance scoring and verification capabilities.

In an embodiment, the metadata augmentation module 108 may generate an augmented individual user data footprint through supplemental user data, including watermark and authorization data on a territory basis. In some implementations, the metadata augmentation module 108 may generate watermarked datasets to uniquely identify data ownership and detect unauthorized distribution. Further, the metadata augmentation module 108 may embed territory-based authorizations in the dataset to enforce jurisdictional compliance for data transactions. The metadata augmentation module 108 may enhance the integrity, compliance, and usability of datasets within the dataset marketplace system 100 and ensure that data footprints maintain their value while complying with regulatory requirements. In an embodiment, the metadata augmentation module 108 may enhance datasets by appending supplemental metadata, including contextual attributes, lineage details, and industry-relevant tagging. Such metadata enrichment process may ensure that datasets contain descriptive insights, improving their searchability, classification, and analytical usability.

In some embodiments, the system may support score augmentation workflows, wherein a low PIDA score, such as one resulting from data sparsity, missing attributes, or low-confidence values, can trigger one or more targeted data enrichment processes. The metadata augmentation module 108 may be extended to supplement or replace missing data elements from trusted external sources, user-authorized secondary repositories, or synthesized imputations, with the goal of enhancing the dataset's overall quality, coverage, or industry relevance. While such dynamic enrichment mechanisms may not be required for baseline operations, the system 100 may be designed to support future extensions wherein data augmentation routines may be contextually invoked to raise a dataset's PIDA footprint or attribute value score. These routines may also include user feedback loops, buyer-side suggestions, or marketplace incentives for enrichment, all of which can be addressed in further optional enhancements. The metadata augmentation module 108 may attach additional attributes such as dataset creation timestamps, modification logs, access permissions, content-specific annotations and other known techniques to improve the accuracy and completeness of structured data assets. In some implementations, the metadata augmentation module 108 may generate related semantic metadata, allowing AI models and machine learning systems to extract context-aware insights from structured datasets.

In an embodiment, the metadata augmentation module 108 may generate watermarked datasets to uniquely identify data ownership and trace unauthorized use. The metadata augmentation module 108 may apply cryptographic watermarking techniques, such as digital fingerprints, steganographic encoding, and blockchain-anchored ownership markers, to ensure that datasets remain verifiable and tamper-resistant. In some implementations, the metadata augmentation module 108 may use invisible watermarking techniques, embedding proprietary identifiers at the structural level of the dataset to prevent unauthorized distribution while preserving data usability. Additionally, traceable watermarking mechanisms may allow dataset owners to track dataset usage and detect potential misuse within the marketplace. In another embodiment, the metadata augmentation module 108 may embed territory-based authorization data into datasets, ensuring compliance with regional data protection regulations. The metadata augmentation module 108 may retrieve applicable jurisdictional rules from regulatory registry computing systems and legal compliance databases and attach territory-specific authorization policies to datasets before they are made available for transactions. In some implementations, the metadata augmentation module 108 may automatically restrict access to datasets based on jurisdictional constraints, ensuring that datasets originating from certain regions remain accessible only to authorized consumers who comply with local data protection laws. Additionally, the metadata augmentation module 108 may encrypt and tokenize datasets to ensure that only legally authorized entities can access or decrypt specific dataset attributes based on geographic policies.

In an embodiment, the metadata augmentation module 108 may support multi-layered data enrichment, where datasets are processed through one or more contextual metadata augmentation pipelines before being scored and made available in the dataset marketplace. Such multi-layered approach may ensure that datasets are not only structured and scored but also contain enhanced metadata attributes that improve their usability across multiple industries and AI-driven applications. Further, the metadata augmentation module 108 may enable metadata governance and version control, ensuring that dataset modifications, lineage, and updates are fully traceable and auditable. In an embodiment, the metadata augmentation module 108 may integrate with provenance verification and scoring mechanisms, ensuring that metadata-enriched datasets retain their trust rating throughout the dataset lifecycle.

In an embodiment, the data scoring module 110 may process the augmented user data footprint, score the same based on industry-specific parameters and weightings, and generate one or more user data registries on an industry-by-industry basis. In some implementations, the data scoring module 110 may apply customizable Privacy-Inclusive Data Access (PIDA) scoring to evaluate the quality and industry relevance of user datasets based on privacy settings, completeness, and usability. Further, the data scoring module 110 may dynamically adjust the PIDA score based on user privacy preferences and industry demand for specific data attributes. The data scoring module 110 may quantify dataset quality with a dataset quality score, ensuring compliance with privacy constraints, and enabling data valuation for marketplace transactions. In one embodiment, the data scoring module 110 may apply one or more multi-parameter assessment models to evaluate datasets based on structural integrity, provenance trust ratings, completeness, and usability. The data scoring module 110 may assign industry-specific weights to dataset attributes, ensuring that scoring models align with sectoral requirements. For example, in healthcare applications, the datasets may be evaluated based on patient record accuracy, diagnostic annotation completeness, and/or regulatory compliance. In e-commerce, the datasets may be scored based on consumer behavior insights, purchase history consistency, and/or sentiment analysis metadata. Other examples will be apparent to skilled artisans from the present teachings. The data scoring module 110 may enable dynamic re-scoring, allowing datasets to be re-evaluated when additional metadata is appended or privacy settings are modified.

In an embodiment, the data scoring module 110 may apply the PIDA scoring to assess data privacy settings and user-defined access restrictions. The data scoring module 110 may evaluate whether datasets contain anonymized or pseudonymized attributes, differential privacy measures, or encrypted elements and adjust the PIDA score accordingly. Datasets with strong privacy-preserving features receive higher scores in privacy-sensitive industries, while datasets with open access attributes may have higher valuations for general-purpose AI training models. The PIDA scoring framework may ensure that datasets are ranked based on both privacy settings and usability, creating a balance between data accessibility and ethical compliance. In yet another embodiment, the data scoring module 110 may support adaptive industry scoring, allowing datasets to be scored differently across multiple industries. The data scoring module 110 may enable multi-sector scoring models, wherein a dataset may receive different valuations based on its relevance in various domains. For instance, a transaction dataset containing anonymized financial records may receive a high score for fintech applications but a lower score for AI-driven medical analytics. The data scoring module 110 may facilitate cross-industry dataset valuation, ensuring that data providers can maximize dataset utilization across multiple market segments.

In some embodiments, the data scoring module 110 may integrate with marketplace pricing algorithms, ensuring that dataset pricing aligns with its industry ranking and privacy attributes. The data scoring module 110 may interface with automated pricing engines, allowing dataset sellers to define price floors for a dataset based on scoring models. Additionally, the data scoring module 110 may support historical trend analysis, wherein datasets with higher marketplace demand may receive a dataset trend score boost, reflecting real-time market interest and buyer activity. In another embodiment, the data scoring module 110 may incorporate compliance-based scoring mechanisms, ensuring that datasets have compliance scores meeting jurisdictional and industry-specific regulatory standards before they are transacted within the dataset marketplace. The data scoring module 110 may assess datasets for compliance with GDPR, HIPAA, CCPA, and other privacy frameworks, assigning distinct regulatory trust scores that determine their eligibility for industry-specific applications. Datasets that fail to meet compliance thresholds may be flagged for further anonymization or regulatory adjustment treatments before they are made available for purchase or licensing. In some implementations, the data scoring module 110 may enable real-time dataset feedback loops, wherein buyers and industry participants contribute market scores, derived from scoring insights based on dataset performance and usability to such entities. Such dynamic feedback integration may ensure that datasets include a variety of scoring factors and remain continuously optimized for industry adoption, allowing score recalibrations based on real-world utilization metrics.

In an embodiment, the marketplace creator exchange module 112 may enable transacting of datasets from the one or more user data registries between users supplying data for said datasets and entities desiring to acquire the same. In some implementations, the marketplace creator exchange module 112 may enable users to define customized privacy charters, allowing them to selectively share data attributes based on an industry type and a buyer reputation score meeting a target threshold. Further, the marketplace creator exchange module 112 may provide automated compensation mechanisms, including smart contracts, tokenized payments, or royalty-based transactions, for users sharing and transacting ownership and use rights in high-value data footprints. In some embodiments, the marketplace creator exchange module 112 may include compliance verification tools that assess potential data buyers against privacy regulations, industry standards, and ethical AI practices and qualify an associated buyer reputation score before approving data transactions. Further, the marketplace creator exchange module 112 may support multi-party data transactions, allowing multiple buyers to access and acquire rights in separate and independent segmented portions of the dataset based on customized access permissions. In an embodiment, the marketplace creator exchange module 112 may serve as a centralized or decentralized data transaction platform, facilitating secure, privacy-compliant, and verifiable exchanges of rights in datasets. The marketplace creator exchange module 112 may allow data providers to list their datasets in a structured marketplace environment, where potential buyers can browse, analyze, and purchase rights in datasets based on industry-specific attributes.

In an embodiment, the marketplace creator exchange module 112 may enable users to define customized privacy charters, specifying the conditions under which their data may be accessed, uses permitted (exploitations), or purchased. The privacy charter framework may allow data providers to establish attribute-level access controls, ensuring that certain dataset attributes remain restricted, anonymized, or encrypted based on buyer reputation, industry compliance, or regional regulations. For example, a healthcare dataset provider may specify that only certified or confirmed HIPAA-compliant buyers can access patient-derived datasets, whereas an e-commerce dataset provider may allow broader access to anonymized consumer behavior insights with fewer buyer reputation requirements. In yet another embodiment, the marketplace creator exchange module 112 may support automated compensation mechanisms, ensuring that data contributors receive fair and verifiable compensation for their shared datasets. The marketplace creator exchange module 112 may integrate with blockchain-based smart contracts, allowing automated royalty distribution, tokenized payments, and recurring licensing models for datasets with ongoing monetization potential. In some implementations, dynamic pricing models may be incorporated, where dataset valuation fluctuates based on demand, buyer engagement, and/or market trends.

In an embodiment, the marketplace creator exchange module 112 may include compliance verification tools that validate potential data buyers through an associated buyer compliance score against regulatory standards, ethical AI guidelines, and contractual agreements before approving transactions. The marketplace creator exchange module 112 may interface with third-party compliance services to determine buyer compliance scores, allowing the verification of corporate identity, industry compliance certifications, and legal data access rights through such entities. Such mechanism may ensure that sensitive datasets are only transacted between authorized entities, mitigating the risk of unauthorized access, data misuse, or regulatory violations. In an embodiment, the marketplace creator exchange module 112 may enable multi-party data transactions, wherein multiple buyers can access separate, independent rights in segmented portions of a dataset based on customized access permissions. Further, the marketplace creator exchange module 112 may support tiered access models, allowing different levels of dataset granularity to be accessed by different buyers based on their purchase level, licensing agreement, or subscription plan. For example, a financial dataset provider may allow full dataset access or complete records to institutional clients while offering only aggregated insights to lower-tier buyers. In an embodiment, the marketplace creator exchange module 112 may facilitate real-time data streaming agreements, allowing buyers to subscribe to continuously updating datasets rather than purchasing static data snapshots. In some implementations, the marketplace creator exchange module 112 may enable reputation-based buyer-seller matchmaking, where data providers can choose to engage only with high-trust buyers meeting a target reputation score. Further, the marketplace creator exchange module 112 may assign transaction history scores, feedback ratings, and compliance scores to both data providers and buyers, ensuring that marketplace transactions remain transparent, secure, and high-quality.

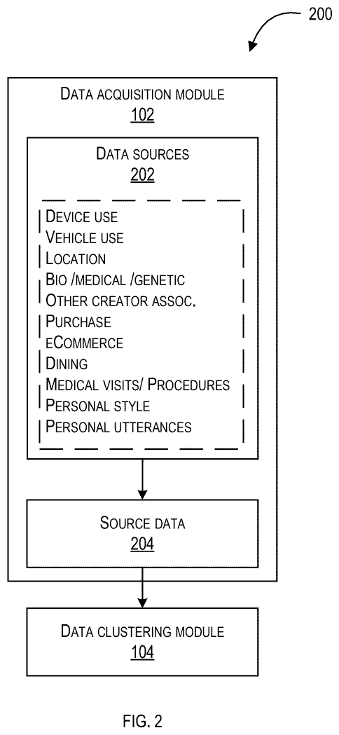

FIG. 2 is a flow diagram 200 illustrating processes employed by the data acquisition module 102 as part of supporting the dataset marketplace system 100, in accordance with an embodiment of the present disclosure. As discussed in previous paragraphs, the data acquisition module 102 may be responsible for collecting source data 204 from various data sources 202, ensuring that datasets are structured, enriched, and made available for further processing in the data clustering module 104.

In an embodiment, the source data 204 footprints may originate from and/or be created by a creator (or an authorized electronic agent on their behalf) that may, without any limitation, correspond to a human being whose actions or attributes generate data. The source data 204 can be directly or indirectly generated by the creator (or an agent on their behalf) and may include transactional data, biometric data, behavioral insights, and contextual life events. For example, transactional data may be derived from activities such as purchases, dining at a restaurant, online orders, or financial transactions using credit cards and other monetary instruments. Similarly, biometric or behavioral source data may be based on spoken utterances, clothing preferences, genetic markers, medical history, test results, and other physiological attributes. It will be understood that any user created can be sourced as needed for a particular industry application. In an embodiment, the system 100 may ensure that each dataset is tagged, validated, and structured before further processing.

In an embodiment, the data sources 202 may encompass a wide range of input channels contributing to the source data 204 footprint. The source data 204 may, without any limitation, include device usage patterns, vehicle activity logs, geolocation tracking, biomedical and genetic records, creator associations (such as frequent interactions with other users), e-commerce transactions, dining history, medical visits or procedures, personal styling preferences, and spoken utterances. The system 100 may capture, normalize, and categorize the source data 204, ensuring that it is linked to one or more creator IDs and associated device IDs. In yet another embodiment, the source data 204 may include life events associated with a creator, where life events may refer to major personal, professional, or technological changes. Further, the life events may include device replacements (such as acquiring a new phone, television, car, and/or IP address), changes in social or professional circles (such as forming new relationships, family expansions, or new coworkers), and geolocation changes (such as moving to a new residence, switching jobs, or frequenting new places). The data acquisition module 102 may capture the life events in real-time, batch mode, or through API integrations, ensuring that datasets remain dynamic and reflective of real-world changes.

In some embodiments, the source data 204 may be linked to one or more Source Device IDs and Associated Human Creator IDs to facilitate provenance assignments of data items to unique individuals. The Source Device IDs may, without any limitation, include industry-recognized identifiers such as merchant terminal IDs, mobile device IDs, household IDs, and network hardware identifiers (such as the Ethernet 48-bit MAC address or IP address). Further, advanced device graph IDs and digital fingerprints may be utilized to establish unique device-user mappings, ensuring reliable provenance tracking. Similarly, associated human creator IDs may consist of known or anonymous user identifiers, ensuring that datasets are linked to their respective originators without exposing personally identifiable information (PII) unless explicitly permitted. In an embodiment, the source data footprint method follows a structured sequence of operations to ensure data integrity, association, and security. First, source data 204 is obtained from various data sources 202 in real-time, via API, time-delayed processing, or batch imports. The data sources 202 may include merchant networks (e.g., Visa, FISERVE), credit bureaus, data brokers (location intelligence, property ownership, etc.), health data exchanges (HL7, HIEs), vehicle data aggregators (car manufacturers, black box data providers), and IoT devices embedded in households, workplaces, and wearables.

In an embodiment, source to creator keys are generated and attached to source data 204 to establish Creator-specific associations. The creator keys may include one or more Creator GUIDs (Globally Unique Identifiers), timestamps, reference fingerprints, and digital watermarks to ensure persistent linkage between datasets and their originating Creators. The Source to Creator Keys provides a cryptographic assurance that the dataset has been collected, processed, and attributed correctly. In an embodiment, the source data 204 with its associated Creator keys may be stored in one or more secure and encrypted repositories, ensuring that dataset duplication and redundancy are minimized. The system 100 may allow virtualized data associations, meaning that the source data 204 does not necessarily need to be physically copied. Instead, it can be linked through reference keys and data graphs, allowing on-demand access to structured datasets without requiring multiple storage replications. In some embodiments, data integrity mechanisms are embedded within the source data 204 to ensure tamper resistance, verification, and security. The mechanisms may include Cyclic Redundancy Checks (CRC), encryption protocols, selective watermarking, and cryptographic hashing to validate data authenticity before marketplace transactions occur.

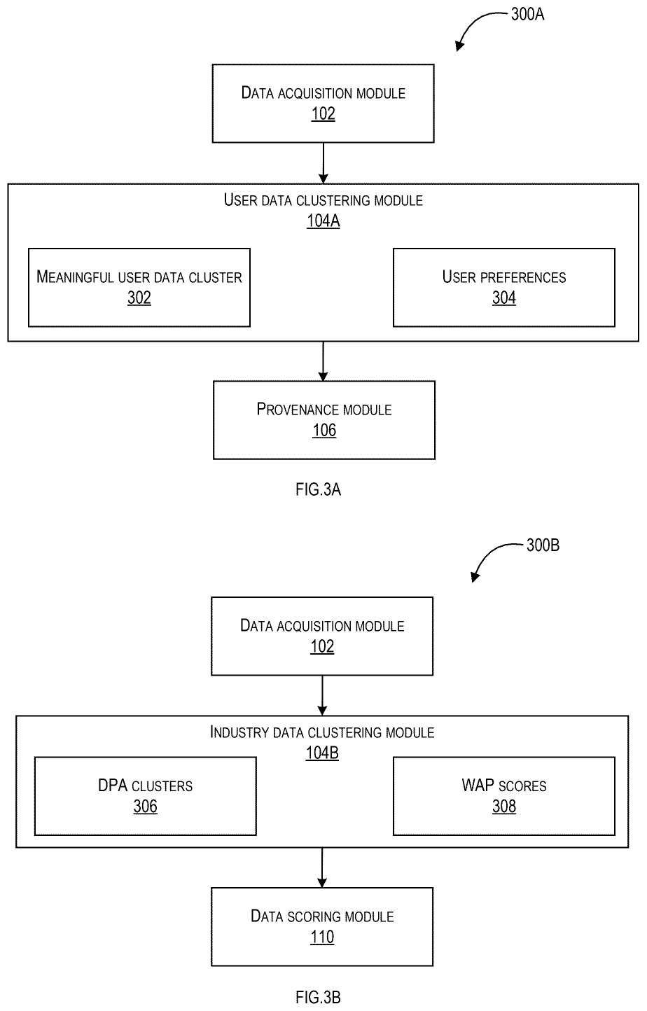

FIG. 3A is a flow diagram 300A illustrating processes employed by a user data clustering module 104A as part of supporting the dataset marketplace system 100, in accordance with an embodiment of the present disclosure. FIG. 3B is a flow diagram 300B illustrating processes employed by an industry data clustering module 104B as part of supporting the dataset marketplace system 100, in accordance with an embodiment of the present disclosure. For the sake of brevity, FIGS. 3A and 3B have been explained together.

In an embodiment, the user data clustering module 104A processes the source data 204 collected by the data acquisition module 102 and structures it into useful and meaningful target sets of user data clusters 302. The user data clustering module 104A applies machine learning algorithms, including unsupervised clustering and Natural Language Processing (NLP), to segment user-generated datasets into logical groupings based on behavioral patterns, transactional history, biometric markers, life events, and contextual interactions. The groupings may ensure that data is structured in a way that is relevant, actionable, and privacy-compliant, making it more valuable for transactions within the dataset marketplace. In an embodiment, the user data clustering module 104A may processes user preferences 304 to enhance dataset segmentation. The user preferences 304 may include individual or system-defined parameters, such as data sharing preferences, privacy settings, and consent-based data classifications. The system 100 may ensure that user-defined preferences are incorporated into the clustering logic, allowing users to exercise control over how their data is categorized and utilized. For example, a user may choose to opt-out of specific industry clusters or apply granular privacy filters to restrict access to personally identifiable data attributes.

In an embodiment, the industry data clustering module 104B may organize structured datasets into multiple DPA clusters 306, ensuring that data assets are aligned with industry-specific taxonomies and compliance requirements. The DPA clusters 306 may refer to Data Processing Agreement (DPA)-compliant clusters, where datasets are structured according to regional data protection regulations, industry governance frameworks, and sector-specific compliance needs. The clustering performed by the industry data clustering module 104B may ensure that data is categorized into a set of industry classifications. The industry classifications may include healthcare, financial transactions, artificial intelligence, and/or consumer behavior analytics. By structuring datasets into the DPA clusters 306, the system 100 may ensure that data trustworthiness and regulatory adherence are maintained and confirmed before allowing the datasets to enter the dataset marketplace system 100. In some embodiments, the industry data clustering module 104B may assign a WAP (Weighted Average Privacy) score 308 to clustered datasets before making them available for marketplace transactions. The WAP scores 308 may serve as a quantitative measure of data quality, trustworthiness, exploitations permitted, and compliance. Further, the WAP scores 308 may be calculated based on multiple factors, including dataset completeness, provenance reliability, user consent adherence, industry-standard compliance ratings, and other AI technology driven clustering. A higher WAP score 308 may indicate that a dataset has undergone rigorous validation, structured compliance assessments, and multi-source verification, making it more valuable within the dataset marketplace system for a particular exploitation by an industry buyer 100.

In another embodiment, the user data clustering module 104A and industry data clustering module 104B may dynamically update meaningful user data clusters 302, user preferences 304, DPA clusters 306, and WAP scores 308 based on real-time transactions, marketplace feedback, and third-party compliance checks. If a particular dataset gains credibility through repeated verified transactions, its WAP score 308 may correspondingly increase. Conversely, a dataset flagged for inconsistencies or regulatory violations may experience a score reduction.

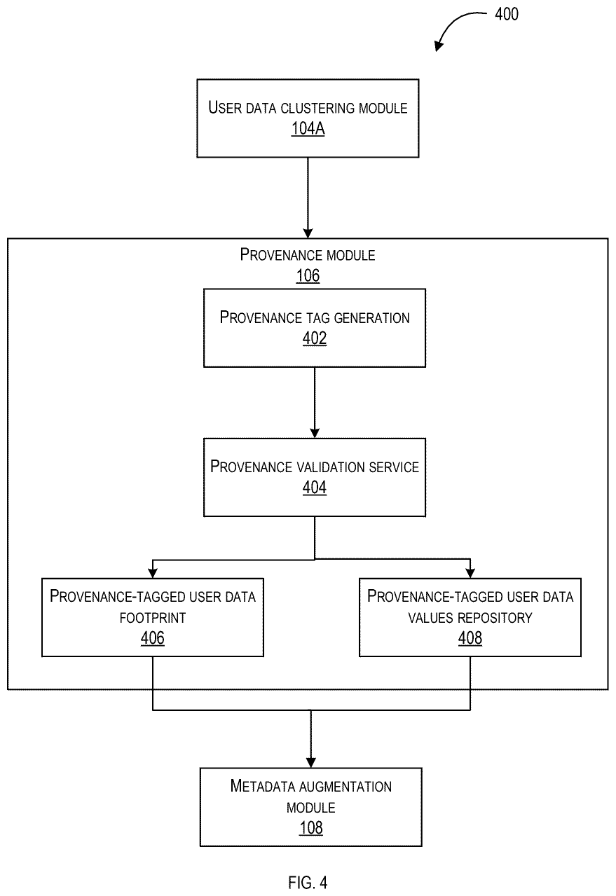

FIG. 4 is a flow diagram 400 describing processes performed by the provenance module 106, in accordance with an embodiment of the present disclosure.

In an embodiment, the provenance module 106 may generate, validate, and store provenance metadata associated with user data within the dataset marketplace system 100. The provenance module 106 may ensure that all datasets are assigned verifiable provenance tags, undergo validation, and are securely stored for future transactions. An overall provenance score may be computed as well for a single user data footprint, and/or an entire dataset. The provenance process may enhance dataset authenticity, allowing users and marketplace participants to evaluate dataset integrity and trustworthiness through a determined provenance score before engaging in data transactions. In an embodiment, the user data clustering module 104A may provide structured datasets to the provenance module 106, where provenance-related metadata is generated and assigned to the clustered user data. The first step in the provenance process is performed by the provenance tag generation 402, which generates unique provenance tags for datasets. The provenance tags may include metadata attributes such as the data source, Creator ID, Source Creator Key, data generation timestamp, transmission timestamps, reference fingerprints, and watermarks. The Source Creator Key may uniquely identify the dataset and ensure that each piece of source data has a traceable origin. In some implementations, watermarking techniques, including industry and government watermarks, may be applied to datasets to ensure ownership tracking and prevent unauthorized modifications.

In an embodiment, once the provenance tag generation 402 may assign provenance tags to datasets, the provenance validation service 404 assesses provenance scores, performs trust verification, consistency checks, and compliance validation to ensure that provenance-tagged datasets meet the required targeted integrity standards, including any required provenance target thresholds. The provenance validation service 404 may cross-verify datasets against trusted industry records, cryptographic signatures, and selectively applies watermarking mechanisms to prevent tampering. Further, the validation step may involve geo-mapping datasets to specific territories or jurisdictions, ensuring that datasets are aligned with regional data protection laws. In some implementations, source validation tokens are generated and linked to the validated datasets, further strengthening dataset integrity. In another embodiment, after validation, the provenance module 106 may categorize provenance-tagged datasets into two repositories, the provenance-tagged user data footprint 406 and the provenance-tagged user data values repository 408. The provenance-tagged user data footprint 406 may store Creator-specific datasets that retain traceable provenance metadata. Further, the provenance-tagged user data footprint 406 may be private to the Creator and its authorized agents, allowing only designated users, AI models, or organizations to access provenance-verified datasets. The provenance-tagged user data values repository 408, on the other hand, may store aggregated provenance-tagged datasets that are made available for broader marketplace transactions, including with associated provenance scores. The datasets may be enriched with market-specific data descriptors, ensuring that they meet industry demands before they are transacted in the dataset marketplace system.

In an embodiment, the provenance-tagged user data footprint 406 may be processed using a Creator Footprint Repository Creation Method, ensuring that datasets retain their integrity, provenance attributes, and multi-source ownership tracking. The Creator Footprint Repository Creation Method may consist of several steps, including extracting or linking datasets to source data, associating datasets with source assertion tokens, aggregating and enriching source data based on market needs, and defining source data ownership splits. The ownership splits may be determined based on percentage allocations, jurisdictional rules, or third-party permission layers, ensuring that multiple contributors to a dataset receive appropriate recognition and compensation. In another embodiment, the provenance module 106 may ensure that no tampering of source data occurs, employing cryptographic hash functions, watermarks, and digital fingerprints to protect dataset integrity. Industry and government watermarking mechanisms may be applied and stored alongside provenance metadata, ensuring that datasets remain compliant with industry regulations and retain a traceable ownership lineage. Such watermarking mechanisms may enhance trust-based dataset transactions, allowing users in the dataset marketplace system 100 to confidently acquire datasets with verified provenance history. In yet another embodiment, once provenance-tagged datasets are validated and categorized, they are forwarded to the metadata augmentation module 108, where additional metadata attributes, privacy-enhancing techniques, and authorization policies are applied.

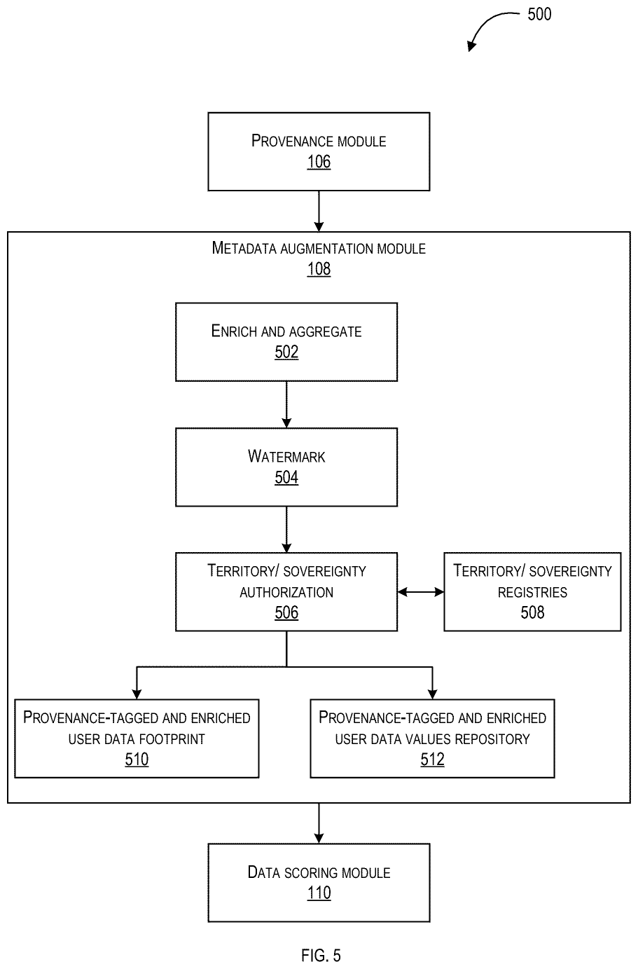

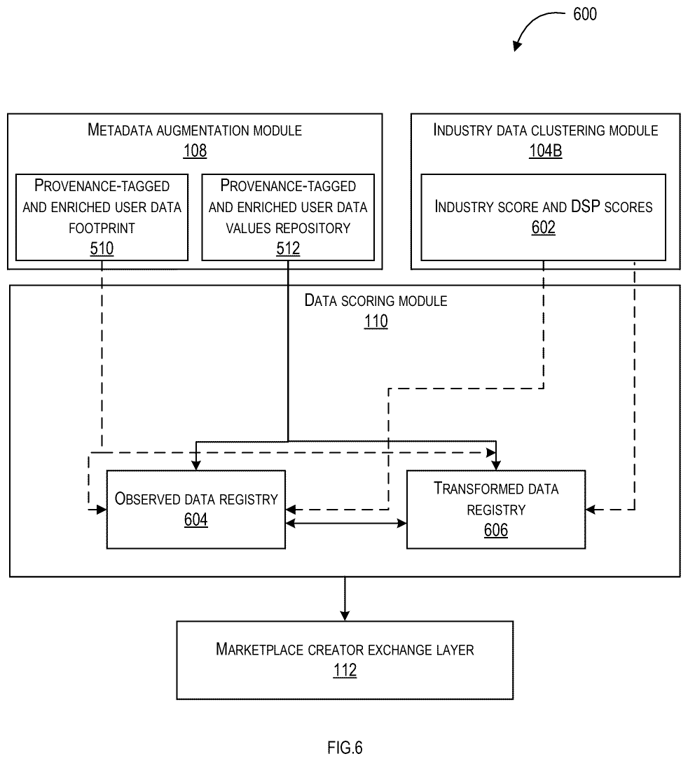

FIG. 5 is a flow diagram 500 describing processes performed by the metadata augmentation module 108, in accordance with an embodiment of the present disclosure. In an embodiment, the metadata augmentation module 108 ensures that datasets are processed with contextual metadata, territorial restrictions, and provenance validation, thereby enhancing their security, usability, and compliance with regulatory requirements before marketplace transactions occur.

In an embodiment, after receiving provenance-validated datasets from the provenance module 106, the metadata augmentation module 108 initiates the enrich and aggregate process 502, where datasets are supplemented with additional metadata attributes, industry-specific data descriptors, and structured tagging to enhance their value in the dataset marketplace. The enrichment process may include combining multiple data sources, adding contextual insights, and generating classification markers that facilitate industry-specific data utilization and ensure data sets are structured to increase the likelihood that it is protected as an asset potentially with rights such as sui generis, copyright, and others in a respective territory. Aggregation processes ensure that datasets are optimized for structured storage and retrieval, improving their relevance for marketplace buyers. In an embodiment, once datasets are enriched, they undergo a watermarking process 504, where unique digital identifiers, cryptographic markers, and industry-compliant security mechanisms are embedded into the data. The watermarking techniques may ensure ownership tracking, prevent unauthorized redistribution, and enforce dataset authenticity. Further, the watermarking may be selective, meaning that different attributes of a dataset may receive different watermarking levels based on the dataset's intended use, compliance requirements, and industry regulations. In some implementations, blockchain-based digital watermarks may be embedded, ensuring that datasets remain immutable and verifiable across multiple transactions.

In an embodiment, the datasets must undergo territory/sovereignty authorization 506 before they can be transacted in the dataset marketplace. The territory/sovereignty authorization 506 processes may include verifying (including by accessing a sovereign controlled registry computing system—not shown) whether a dataset is permitted for sale or use within specific geographical regions based on content, formatting, user privacy rights, and other known factors. Such verification may ensure compliance with territory-specific data protection laws and AI governance frameworks. Further, the territory/sovereignty authorization 506 processes may check multiple territory sovereignty registries 508, which maintain records of geo-based data authorization policies, governmental data protection laws, and industry-specific regulatory frameworks. The system 100 queries these registries to determine whether the Creator is allowed to license or sell their dataset in a particular territory. In some embodiments, the territory/sovereignty authorization 506 processes may include generating Geo Data Element Auth Tokens, which serve as cryptographic proof that a dataset is approved for use in a given jurisdiction. The tokens may be public-private certificates (e.g., x509-based) or blockchain-issued authorization records, ensuring that dataset transactions comply with regulatory requirements before they are executed in the marketplace. Further, territory-specific compliance checks may be conducted on buyers and industry participants, ensuring that they meet territory-mandated trust score thresholds before being permitted to transact with Creator data footprints.

In another embodiment, individual datasets that have successfully passed territory/sovereignty authorization 506 are categorized into two repositories, the provenance-tagged and enriched user data footprint 510 and the provenance-tagged and enriched user data values repository 512. The provenance-tagged and enriched user data footprint 510 may store Creator-specific datasets that have been enriched, watermarked, and verified for territory-based transactions. The datasets may retain traceable provenance attributes, regulatory compliance metadata, and security markers, ensuring that they can only be transacted under verified, compliant conditions. The provenance-tagged and enriched user data values repository 512, on the other hand, may store aggregated and structured enriched datasets that are formatted for broader industry applications. The datasets may be structured to support AI training models, financial analysis, healthcare research, and consumer behavior insights, ensuring that they are market-ready and industry-compliant.

In some embodiments, the provenance-tagged and enriched user data footprint 510 may be processed using a Creator Registry Method, which ensures that Creator data footprints are protected, registered, and managed as intellectual assets. The Creator Registry Method may perform an exploitation profiler analysis, where territory-specific regulations are checked to determine whether a dataset meets the criteria to be recognized as a protected intellectual asset. The criteria may include creativity, human initiation, originality, and provenance verification, ensuring that the dataset is classified as sui generis intellectual property in accordance with international data protection frameworks, such as the Romain Convention countries. In an embodiment, after datasets are profiled for intellectual asset protection, they may undergo modification and compliance structuring to meet the unique data protection requirements of each territory. Once the datasets are compliance-verified, they are registered as exploitable digital assets, ensuring that Creators maintain exclusive rights to license, distribute, or monetize their datasets. In some cases, the datasets may also be registered under copyright, trademark, or sui generis data protection laws, providing long-term legal protection and transaction security.

In an embodiment, the datasets registered in the Creator Registry may undergo reference fingerprinting, where multiple distinct digital fingerprints are generated for corresponding different market segments, jurisdictions, and buyer profiles. The fingerprinting process may ensure that datasets remain uniquely identifiable across transactions, allowing traceability and verification across multiple dataset transactions. Additionally, selective watermarking mechanisms may be applied to datasets, embedding Creator-identifying information and ownership metadata into specific attributes of the dataset. In some implementations, once datasets have been provenance-validated, enriched, territory-authorized, and secured in the appropriate repositories, the data scoring module 110 may evaluate, rank, and price the datasets based on industry-specific scoring metrics.

FIG. 6 is a flow diagram 600 describing processes performed by the dataset scoring module 110 (FIG. 1), in accordance with an embodiment of the present disclosure. The data scoring module 110 may process datasets from multiple sources, including the metadata augmentation module 108 and the industry data clustering module 104B, to generate customized and configurable industry scores, DSP scores, observed data registries, and transformed data registries, ensuring that datasets are market-ready and optimized for transactions.

In an embodiment, the data scoring module 110 may receive provenance-tagged and enriched datasets from the metadata augmentation module 108, specifically from the provenance-tagged and enriched user data footprint 510 (FIG. 5) and the provenance-tagged and enriched user data values repository 512. The datasets may serve as the foundation for transactions in the dataset marketplace, where the data footprint 510 may represent a structured dataset with verified Creator attributes, metadata descriptors, watermarking, geo-based authorizations, and enriched content, while the data values repository 512 may organize datasets based on industry relevance and transactional viability. In an embodiment, the data footprint 510 may represent a logical data template identifying the availability of data fields for potential transactions, such as whether the “gender” field exists and is accessible for a given user dataset, a binary or Boolean presence (e.g., yes/no). The PIDA Footprint Score may reflect this data item's availability across multiple data dimensions. In contrast, the data values repository 512 may contain the actual values of those fields (e.g., “female” for gender), which are scored separately through PIDA Attribute Value Scores. Such value-based scores allow industry buyers to assess specific criteria relevant to their domain. For instance, a pharmaceutical dataset buyer may assign greater importance to “female” as a gender value in the context of breast cancer research, whereas an e-retail buyer may derive value simply from the presence of gender as a field for personalization. Other examples for other industries will be apparent to those skilled in the art. In an embodiment, Machine Learning (ML) techniques (clustering) may be used to create the dimensions around which PIDA scores could be calculated. It may be possible to create categories of user data that could be PIDA score dimensions. For example, a non-exhaustive list of data categories may, without any limitation, include demographic, medical, access method/media, financial insurance, occupation/career, likeness, identity data, location, hardware/device, affinities, criminal record, litigation history, education, intellectual property, and transactions/commerce. It may be noted that each dimension of user data may have any number of data elements. An example, of demographic and hardware/device data elements has been shown below:

| | DATA |
|---|---|
| | AVAILABILITY |
| DEMOGRAPHIC | |
| Gender | 1 |
| Age cohort | 1 |
| Age in years | 1 |
| Marital status | 1 |
| Parenthood | 1 |
| No. of children | 1 |
| Sexual Orientation | |
| Ethnicity | |
| HARDWARE DEVICE | |
| Screen type/size | 1 |
| Device type | 1 |
| Location of | 1 |
| consumption | |
| Timestamp of | 1 |
| consumption | |
| Spectrum/access | 1 |
| medium | |

In another embodiment, the data scoring module 110 may incorporate industry score and DSP scores 602 obtained from the industry data clustering module 104B to assess dataset usability, compliance adherence, and commercial potential. The industry score and DSP scores 602 may be generated using Data Processing Agreements (DPAs), privacy compliance metrics, Weighted Average Privacy (WAP) scores 308, buyer-seller compatibility assessments, and other reference data. The industry score and DSP scores 602 may allow data Creators to evaluate the trustworthiness of potential buyers against a desired target reputation threshold, ensuring that transactions align with creator privacy charters and industry-specific regulations. In an embodiment, industry score and DSP scores 602 are derived from a comprehensive analysis of industry trends, data processing frameworks, and regulatory compliance standards. Data Processing Agreements (DPAs) may be parsed and clustered using machine learning techniques to determine whether a dataset aligns with industry standards and privacy expectations. The DSP score may be refined based on factors such as the number of transactions completed, transaction pricing trends, compliance certifications, regulatory adherence, reputation scores from platforms like Better Business Bureau (BBB) and Glassdoor, litigation history, financial stability, and AI governance practices. By integrating industry and DSP scores 602 into the dataset scoring process, the data scoring module 110 may enhance marketplace transparency, allowing participants to assess datasets based on industry-aligned trust scores and compliance records.

In an embodiment, the data scoring module 110 may structure datasets into two primary registries, including observed data registry 604 and transformed data registry 606. The observed data registry 604 may be an encrypted repository for all collected user data, behavioral interactions, transaction timestamps, and metadata attributes, ensuring that datasets are properly indexed and secured. The storage medium for the observed data registry 604 may include edge computing devices, cloud-based databases, enterprise-level servers, federated computing systems, or blockchain-distributed ledgers, ensuring that datasets remain accessible in a secure and decentralized environment. The observed data registry 604 may serve as the initial repository before dataset categorization, transformation, and scoring take place. In an embodiment, the transformed data registry 606 may store encrypted datasets that have undergone clustering, footprint PIDA scoring, and industry alignment transformations, making them structured, validated, and transaction-ready. Further, the transformed data registry 606 may ensure that datasets are categorized based on buyer demand, industry-specific regulatory requirements, and commercial potential, allowing for optimized data transactions. For instance, datasets stored in the transformed data registry 606 may include biotech-focused PIDA scores for medical research, financial PIDA scores for transaction-based analysis, and consumer behavior PIDA scores for AI-driven market segmentation. In some implementations, data buyers may specify industry-aligned scoring models that dictate how datasets are ranked, filtered, and prioritized before they are made available for purchase in the dataset marketplace system 100.

In an embodiment, the system 100 may facilitate industry and buyer-specific assignment of weightings to both the Footprint PIDA score and the Attribute Value PIDA score. The weightings may be defined by the data buyer side of the marketplace and reflect the relative priority or utility of specific data dimensions or individual attributes within a given industry. For instance, in one example, a pharmaceutical industry participant may assign higher weight to medical diagnoses, genomic data, and prescription history, while assigning lower importance to location or device usage data. Conversely, an e-retailer may prioritize transaction frequency, brand affinities, and device usage patterns. Such buyer-assigned weightings may be ingested and stored by the system 100 in association with specific PIDA scoring profiles. Further, the data scoring module 110 may apply such weightings during the score computation stage, enabling fine-grained, buyer-optimized valuation of user data footprints. In some embodiments, the system 100 may maintain a library of industry-specific weighting profiles, which may be updated based on real-time ROI feedback from previous transactions. In an additional embodiment, the buyer profiles may also include dimension-level and attribute-level weights, and the system 100 may allow iterative refinement of the weightings over time.

In an embodiment, the marketplace creator exchange layer 112 may facilitate the final stage of dataset transactions, allowing Creators to license, sell, or distribute their data footprints to verified buyers based on pre-defined and customizable scoring models and privacy parameters. The data scoring module 110 may ensure that all datasets entering the marketplace creator exchange layer 112 have undergone industry scoring, compliance validation, and trust score analysis, making them market-ready for structured transactions. In some implementations, data footprint availability and attribute value scoring methods play a key role in dataset valuation within the dataset marketplace system. The footprint availability scoring process may include a footprint completeness score evaluating and reflecting the completeness and accessibility of user data attributes. Further, the footprint availability scoring process may ensure that datasets are ranked based on privacy settings, industry demand, and data completeness. A dataset's availability score is influenced by user-defined privacy preferences, willingness to transact, and industry-specific scoring models. The footprint attribute value scoring process may include evaluating each dataset attribute based on its relevance, accuracy, and value in a given industry sector, ensuring that datasets receive industry-weighted assessments and dynamic ROI metrics based on real-world applications.

In an embodiment, marketplace transactions may generate new observed data, which is continuously fed back into the observed data registry 604, allowing the system 100 to adapt scoring models based on real-world marketplace interactions and transactions. The transformation process may include categorization algorithms, AI-based pattern recognition models, and dataset enrichment frameworks, which refine dataset usability across multiple industry sectors. Over time, marketplace participants may leverage the scoring models to refine dataset rankings, optimize pricing structures, and enhance data accessibility for industry buyers. In an embodiment, data buyers in different industries may customize scoring models based on their specific data needs and industry regulations. For example, pharmaceutical buyers may prioritize datasets containing biometric, medical, and genetic data, whereas financial institutions may focus on transactional behavior, credit risk analysis, and fraud detection attributes.

In some embodiments, the dataset marketplace system 100 may include feedback mechanisms with associated feedback scoring that allow the marketplace to learn from the success or failure of real-world data usage. Without any limitation, one type of feedback may include ratings and scores associated with the performance outcomes of campaigns or use cases in which PIDA-scored datasets were utilized. For example, if a pharmaceutical company uses a dataset characterized by specific Footprint and Attribute Value PIDA scores and successfully develops a new drug formulation, this event constitutes a positive outcome signal. The system 100 may receive this signal as structured feedback and use it as part of a feedback score to increase the valuation, trust, and ranking of other datasets with similar PIDA scoring profiles. Similarly, if a dataset fails to yield value in a campaign (e.g., low ROI, ineffective targeting, or regulatory rejection), that negative feedback may be stored and used to refine matching algorithms and buyer scoring filters. In an embodiment, this feedback loop may be integrated into the transformed dataset registry 606 and the data marketplace exchange module 112 and may enable the system 100 to dynamically adjust scoring weights, industry ROI metrics, and buyer recommendations, thereby enhancing future transactions. In an embodiment, once transformed datasets have been scored and stored in the transformed dataset registry 606, the system proceeds to match supply and demand through rule-based logic. The marketplace exchange module 112 may evaluate incoming buyer requests, which may include parameters such as desired data types, industries, PIDA score thresholds, permitted usage rights, jurisdictional constraints, and target pricing levels, against available annotated and enriched data bundles stored within the registry. The system 100 may identify compatible bundles that satisfy both creator-defined constraints and buyer-side requirements, enabling precise, scalable, and regulation-compliant transactions.

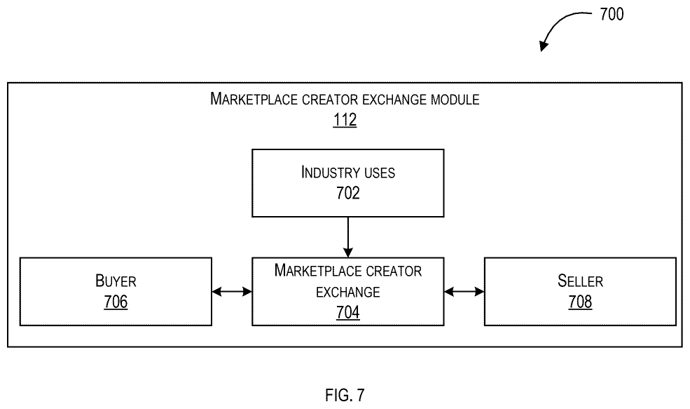

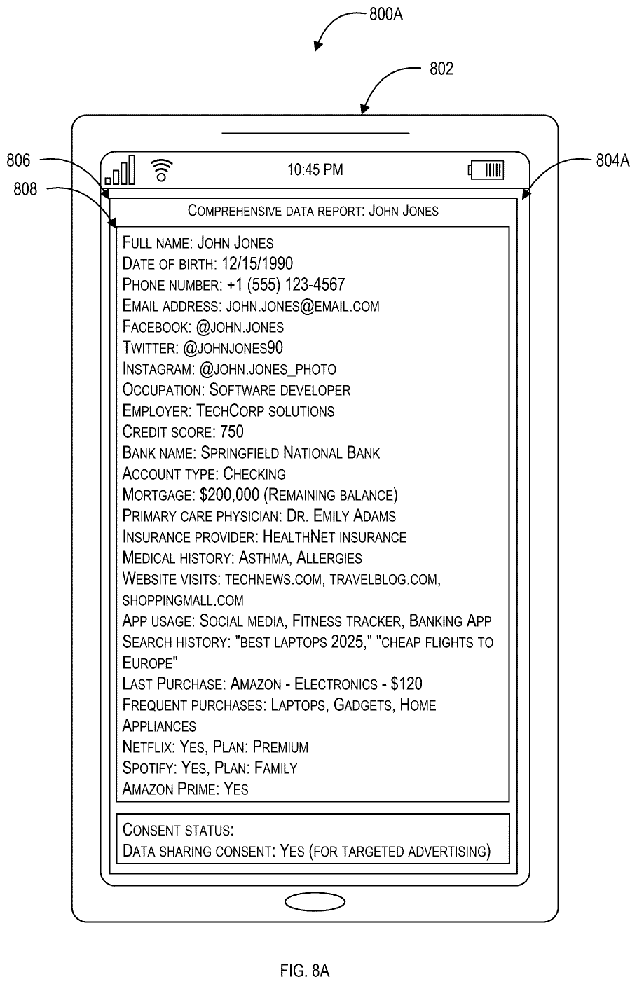

FIG. 7 is a flow diagram 700 describing processes performed by the marketplace creator exchange module 112 (FIG. 1), in accordance with an embodiment of the present disclosure. In an embodiment, the marketplace creator exchange module 112 may facilitate structured data transactions between a buyer 706 and a seller 708 through the marketplace creator exchange 704. The marketplace creator exchange module 112 may ensure datasets are verified, scored, and authorized before transactions can take place for the same, allowing industry participants to acquire high-quality, provenance-verified, and privacy-compliant datasets. In an embodiment, the marketplace creator exchange module 112 may allow buyers to assess datasets based on Footprint PIDA scores, permitted-use policies, and regulatory compliance measures, ensuring that dataset transactions align with privacy frameworks, industry-specific scoring models, and legally accepted use cases.

In an embodiment, the marketplace creator exchange module 112 may incorporate a list or group of configurable industry uses 702, which define how datasets are categorized, ranked, and scored based on their applicability in specific industries. It may be apparent to a person skilled in the art that different industries have unique data valuation metrics, requiring datasets to be evaluated against industry-specific standards before being made available for transactions. For example, datasets that contain biometric and medical records may be highly valuable in the pharmaceutical industry, whereas datasets consisting of consumer behavior, purchase history, and demographic insights are more relevant and valuable to the e-retail sector. The industry uses 702 mechanisms may apply Footprint PIDA scoring to datasets, ensuring that they are assessed based on availability, attribute value, and industry-specific parameters. The Footprint PIDA score may consist of two primary components, including an availability score, which measures the dataset's completeness and accessibility based on privacy charters, and a Footprint Attribute Value score, which quantifies the dataset's intrinsic value within a given industry.

In an embodiment, the marketplace creator exchange module 112 may ensure that buyers 706 are provided with assurances regarding dataset provenance, ownership rights, and permitted uses before engaging in transactions. The buyer 706 may require legally binding warranties and indemnifications to confirm that datasets are sourced from verified entities, legally acquired, and compliant with industry regulations. To address these concerns, the marketplace creator exchange module 112 may assign one or more authorization tokens to datasets, with each corresponding to and confirming target provenance, authenticity, and regulatory approval. The authorization tokens may serve as verification mechanisms to ensure that datasets have undergone compliance screening, legal validation, and security auditing before being transacted in the marketplace. In an embodiment, the marketplace creator exchange module 112 may include a buyer evaluation framework that assesses the buyers 706 based on their compliance with privacy regulations, historical data usage patterns, and permitted-use agreements. In an embodiment, different industries may impose varying levels of regulatory oversight, requiring the marketplace creator exchange module 112 to evaluate buyers using AI-driven classification models and privacy charter validation processes. The buyer evaluation framework may extract historical industry data, transaction records, and regulatory compliance scores to generate buyer-specific industry scores that determine whether a buyer is eligible to engage in dataset transactions. The buyer assessment process categorizes buyer transactions into industry clusters, ensuring that datasets are transacted with authorized and privacy-compliant enterprises only.

In an embodiment, datasets transacted through the marketplace creator exchange module 112 are assigned multiple validation tokens, ensuring that all transactions adhere to dataset provenance standards, regulatory requirements, and industry scoring metrics. The tokenization process may include assigning Source, Provenance, Territory, and Industry tokens to datasets, ensuring that all transactions are fully traceable and legally verifiable. The system 100 may generate Source Provenance Tokens by combining source verification data, provenance records, and industry authorization tokens, ensuring that dataset transactions maintain high levels of transparency and accountability. Additionally, permitted use tokens define the transactional limitations of datasets, specifying which industries, enterprises, and geographic regions are authorized to purchase and utilize the dataset. Further, the system 100 may incorporate return-on-investment (ROI) tracking mechanisms, where buyers provide feedback on dataset usability and effectiveness, enabling continuous improvement in Footprint PIDA scoring methodologies.

In an embodiment, the marketplace creator exchange module 112 may employ a customizable footprint marketplace availability scoring system, which evaluates the accessibility, value, and compliance of datasets before they are made available for industry transactions. The availability scoring framework may include aligning dataset transactions with privacy regulations, industry scoring methodologies, and buyer eligibility criteria. The scoring process may include applying privacy charter-linked evaluations, ensuring that datasets are ranked based on their compliance with user-defined privacy preferences and industry scoring models. The system 100 may apply dimension-weighted scoring, where datasets are ranked within industry-specific scoring clusters to ensure that buyers receive high-value, legally compliant datasets. In some implementations, the marketplace creator exchange module 112 may allow the sellers 708 to define dataset pricing, permitted-use policies, and industry-specific licensing models, ensuring that dataset transactions align with market-driven valuation frameworks. In an embodiment, the marketplace creator exchange 704 may facilitate secure, privacy-compliant transactions by providing structured buyer-seller interactions, where datasets are transacted under predefined industry pricing models, legal compliance standards, and provenance-verification frameworks. Further, the sellers 708 may define data-sharing conditions, intellectual property protections, and industry-specific licensing constraints, ensuring that only authorized buyers can access, process, and utilize the dataset.

In an embodiment, the marketplace creator exchange module 112 may ensure that datasets are transacted in compliance with global data protection regulations, industry best practices, and ethical AI governance standards. The system 100 may apply multi-factor validation frameworks, ensuring that all transactions may maintain data security, ownership transparency, and transactional integrity. Further, the marketplace creator exchange module 112 may integrate dynamic industry scoring mechanisms, ensuring that dataset transactions are aligned with real-time market demand and evolving regulatory requirements. In some implementations, the marketplace creator exchange module 112 may allow industries to customize their dataset scoring models, ensuring that data buyers prioritize relevant attributes based on their sector-specific needs. In an exemplary embodiment, pharmaceutical companies may prioritize datasets containing biometric data, genetic sequencing, and medical history, while financial institutions may require datasets containing consumer credit scores, transaction histories, and fraud detection insights.

In an embodiment, marketplace creator exchange module 112 may include a marketplace registry, separate from the transformed dataset registry 606, that is configured to store post-transaction data such as pricing history, buyer demand signals, exploitation feedback scores, and return-on-investment (ROI) outcomes. The marketplace registry may serve as a financial ledger or audit repository, enabling transparency and traceability of marketplace activity while maintaining logical and/or physical separation from the original Footprint and Value scoring mechanisms. Such separation may ensure that the core scoring systems remain analytically pure and unaffected by market performance, which may be important for compliance, data integrity, or regulatory auditing purposes. In some embodiments, each data bundle may be globally uniquely identified (GUID) and timestamped, allowing the system 100 to trace both original scoring outputs and post-sale modifications or performance feedback without data conflict. Additionally, or alternatively, the marketplace registry may be maintained as a distinct repository linked via metadata referencing and secure API access.

In an embodiment, the dataset marketplace system 100 may recognize certain data as a non-rivalrous good, meaning it can be sold or licensed to multiple buyers without depleting the original dataset. Unlike physical goods (e.g., oil or food), data is not consumed upon use and may retain or even increase in value through reuse, especially when paired with contextually relevant or enriched attributes. Accordingly, the system 100 may support licensing models that allow for multi-party access, including individual non-exclusive licenses, tiered access levels, or time-limited use rights, all of which can be enforced through the metadata augmentation module 108 and stored in the Creator Registry. In an embodiment, pricing mechanisms within the marketplace exchange module 112 may account for these unique non-rivalrous properties by enabling dynamic valuation of datasets based on content type, content depth, usage rights, and market demand. A single data point (e.g., “age=32”) may be priced modestly, while the same point in a context-rich bundle (e.g., cancer diagnosis, treatment protocol, genetic markers, and lifestyle attributes) may command significantly greater value due to its utility in specialized use cases such as clinical research or predictive modeling. The system 100 may therefore present pricing options for individual data points, homogeneous series of similar data, or multi-attribute packages, with pricing adjusted based on industry ROI scores, licensing constraints, prior usage signals, and bundling intelligence.

In an embodiment, the dataset marketplace system 100 may include a compliance and transaction registry configured to maintain a detailed audit trail of all data transactions. Each transaction may be electronically recorded, including timestamp, buyer and seller identifiers, licensing terms, pricing data, and delivery logs. The data bundles transacted may be tagged with tracking codes, digital watermarks, or cryptographic hashes, allowing post-sale tracing, duplication detection, and forensic validation. Other related transaction data can be recorded as well depending on the target application. In some embodiments, automated security agents may monitor buyer-side usage of the dataset in real-time or batch mode, comparing activity logs against the permitted usage terms defined in the license. This may ensure automatic compliance enforcement and generates alerts or usage violations reports if anomalies are detected. The system 100 may optionally expose read-only or API-gated access to one or more registries, such as the Creator Registry, the Transformed Dataset Registry, and the Marketplace Registry, depending on the needs of external regulatory authorities or compliance auditors. For example, within the same jurisdiction, agencies such as the FTC or SEC may require access to financial records and transaction metadata, while health-related agencies such as the FDA may require access to dataset content lineage and usage authorization history.

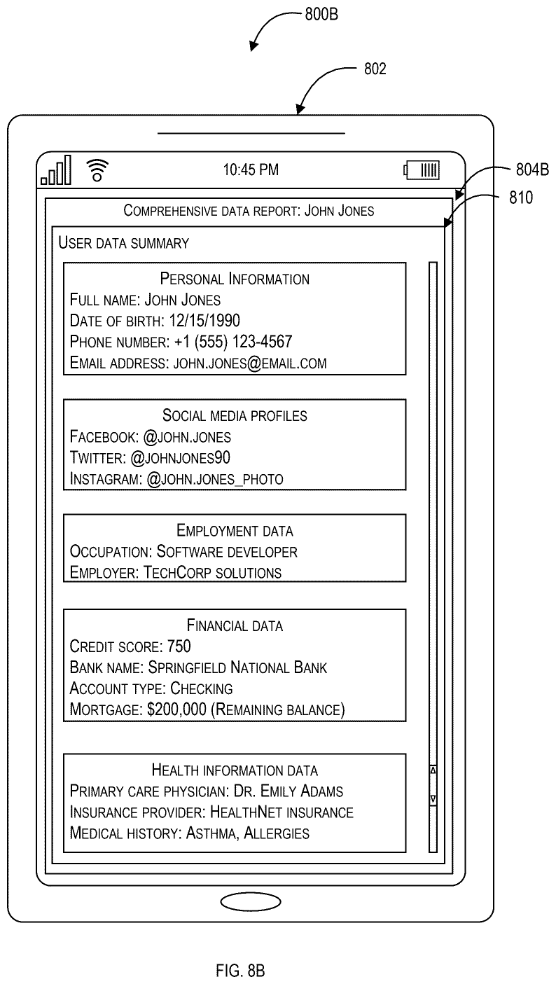

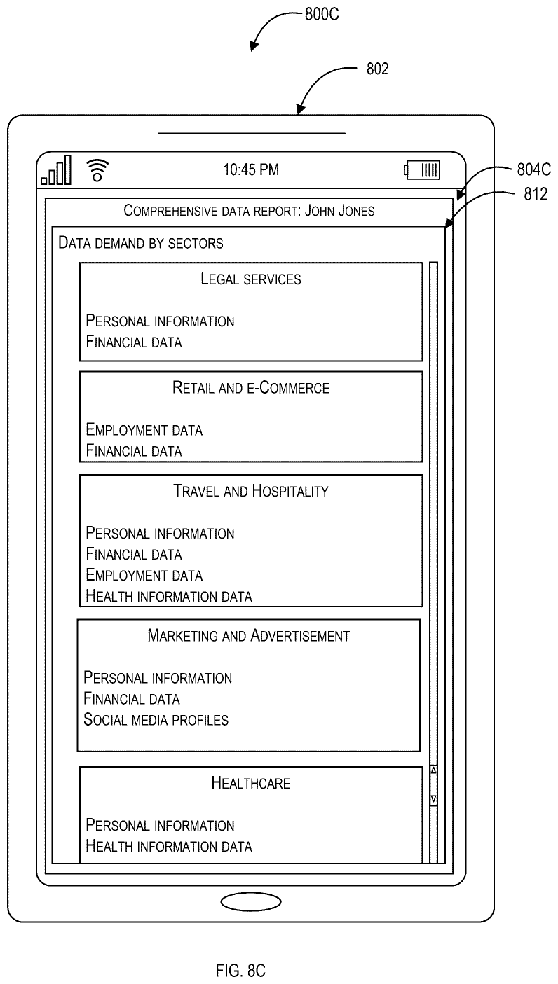

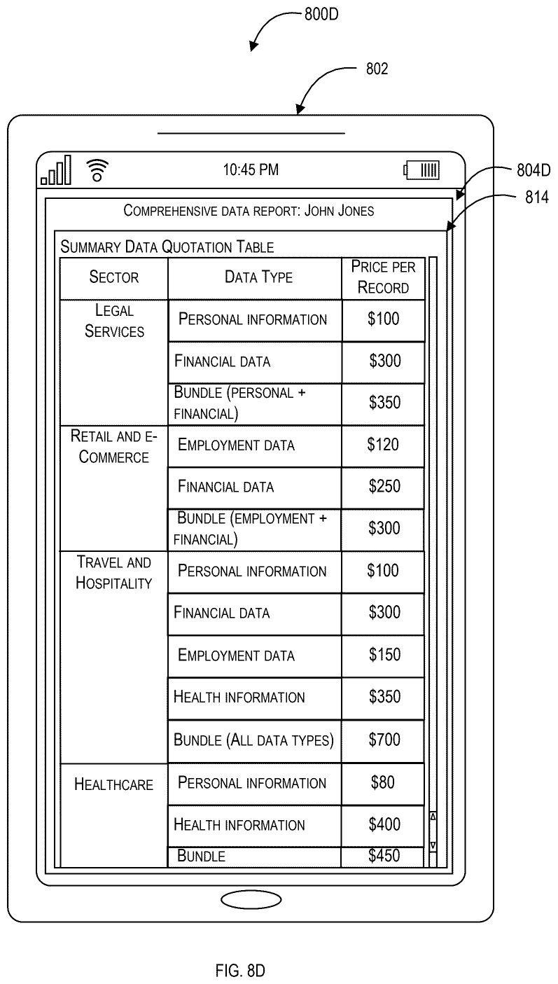

FIGS. 8A-8D are examples 800A, 800B, 800C, 800D of interfaces 804A, 804B, 804C, 804D of a marketplace adapted to enable transacting of datasets, in accordance with an embodiment of the present disclosure. For the sake of brevity, FIGS. 8A-8D have been explained together. Such interfaces, accessible through a user device 802, enable review, categorization, assess demand, and monetize the datasets in a privacy-compliant and industry-aligned manner.

In an embodiment, the interface 804A may display a comprehensive data report 806, which provides an overview of an individual's structured dataset, including various data attributes 808 collected, categorized, and/or scored within the dataset marketplace system 100. This report enables review of the personal data footprint and determine which data elements are eligible for marketplace transactions. Further, the comprehensive data report 806 may consolidate multiple dataset sources, including biometric data, financial history, online transactions, AI training contributions, and consumer behavior analytics, ensuring that data is structured in a manner that aligns with industry-specific buyer requirements. For instance, in a scenario where an individual has engaged in multiple medical consultations and diagnostic tests, their health-related data attributes 808, including prescriptions, doctor visit histories, and lab test results, may be structured for use in pharmaceutical research, clinical trials, or AI-driven diagnostic systems. Similarly, an individual's e-commerce purchasing history and spending behavior may be analyzed for use in market intelligence, retail analytics, and targeted advertising algorithms.

In an embodiment, the interface 804B may display categorization of the data attributes 808 into distinct clusters in a user data summary 810, allowing visualization and organization of the datasets based on industry demand and regulatory requirements. The interface ensures that dataset elements are clearly defined and structured for optimal transactability, while also allowing individuals to modify, refine, or exclude specific data attributes from marketplace participation. The categorization process leverages the data clustering module 104, ensuring that user data is aligned with relevant industry classifications, including healthcare, finance, artificial intelligence, and consumer analytics. For instance, financial transactions may be clustered into spending categories such as discretionary vs. non-discretionary expenses, income sources, and credit utilization patterns, allowing financial institutions to assess consumer behavior for risk modeling and credit scoring applications. In another example, a user's fitness tracking data, including heart rate variability, calorie consumption, and sleep patterns, may be categorized under biometric health data, making it valuable for wearable technology companies, fitness app developers, and insurance providers assessing lifestyle risk factors. Other examples of useful will be apparent to those skilled in the art depending on the target market.

In an embodiment, the interface 804C may display data demand by various sectors, as shown by 812, offering a comprehensive breakdown of industry-specific dataset requirements and transaction preferences. The sectors may, without any limitation, include legal services, retail and E-commerce, travel and hospitality, marketing, pharmaceutical industry, financial sector, advertising, and healthcare. In an embodiment, the dataset marketplace system 100 may include an intelligent data assembly engine capable of dynamically identifying and bundling data elements based on the specific computational or modeling needs of a data buyer. Rather than simply matching buyers with individual categories of data demand, the system 100 may parse intent expressions, campaign goals, or algorithmic requirements submitted by the buyer to determine which clusters of data, potentially spanning multiple data dimensions, are best suited for the intended use case. For example, a pharmaceutical buyer seeking to analyze the impact of life-path variables on treatment efficacy may request “longitudinal lifestyle datasets,” prompting the system 100 to assemble a bundle including occupation history, residential geographies, environmental exposures (e.g., air or water quality), and behavioral health markers. The bundles may be scored dynamically using PIDA Footprint and Value scoring models, enabling customized recommendations based on availability, buyer weighting profiles, and historical performance signals from similar campaigns. Such a smart bundling functionality may enable the marketplace to operate as a data matchmaking agent, using metadata inference, clustering algorithms, and prior transaction feedback to construct meaningful, multi-dimensional data packages for buyers. In some implementations, the bundling engine may also consult buyer-specific weighting schemas (as described earlier) to determine which attributes are essential, optional, or undesirable for inclusion, further optimizing relevance and transaction success rates.

In an embodiment, the interface 804C may further provide users with insights into how different industries prioritize data attributes, assisting users with data selection options and ensuring that they can align their dataset offerings with real-time marketplace demand. For instance, the pharmaceutical industry may show a high demand for anonymized patient health records, medication adherence data, and genomic sequencing reports, while the AI sector may prioritize training datasets containing large-scale image recognition data, NLP-based conversational logs, or behavioral interaction patterns. The financial sector may focus on credit histories, fraud detection models, and spending trends, whereas the insurance industry may assess actuarial risk based on fitness tracking, vehicle telematics, and home security monitoring data. By mapping dataset elements to industry-specific use cases, compliance frameworks, and permitted-use tokens, the data marketplace exchange module 112 ensures that dataset transactions align with buyer requirements while protecting individual privacy and data ownership rights.

In an embodiment, once a buyer and a seller are matched and the transaction price for a dataset or bundle has been agreed upon, either through auction, dynamic pricing engine, or negotiation, a unique data license agreement may be generated by the system. The license may define the terms of the transaction, including, but not limited to, pricing, scope of access (e.g., full dataset, partial access, API-limited views), duration, territorial limitations, permitted uses, and redistribution rights. In certain implementations, the license may be instantiated as a digitally signed legal document, maintained within the Creator Registry or a license ledger. In alternate embodiments, the license may be deployed as a blockchain-based smart contract, enabling tamper-proof enforcement, automated execution of payment and access provisions, and secure, timestamped records of buyer-side compliance. The system 100 may store, audit, and update these license instances as needed, including revocation, expiration, or renewal, providing end-to-end lifecycle control for dataset transactions.

In an embodiment, following the generation of a valid data license agreement, the system 100 may proceed to execute the transaction and deliver the licensed dataset to the buyer in accordance with the specified terms. Access to the data bundle may be provisioned through download portals, API-based endpoints, federated access channels, or secure cloud-based containers. The scope, format, and duration of access may be automatically restricted and enforced by intelligent software agents configured to comply with the license parameters. The software agents may prevent unauthorized redistribution, limit query counts, or restrict geographic access based on embedded metadata or authorization tokens. In some embodiments, the system 100 may also enforce artificial scarcity mechanisms, whereby the same dataset is made available to only a fixed number of buyers, within a predefined time window, or under escalating price conditions, thereby preserving value or exclusivity for high-sensitivity or premium data assets. Transaction logs, delivery receipts, and access metrics may be recorded in the marketplace registry or blockchain layer to ensure traceability, auditability, and compliance.

In an embodiment, the interface 804D may display a summary data quotation table 814, providing a detailed financial breakdown of dataset valuation, pricing metrics, and sector-based compensation models. The interface 804D may enable individuals to evaluate real-time market quotations for their datasets, ensuring that pricing transparency and monetization opportunities are communicated. The summary data quotation table 814 may incorporate Footprint PIDA scoring mechanisms, which dynamically adjust dataset pricing based on industry demand, dataset completeness, privacy inclusion levels, and compliance with buyer expectations. For example, at any moment in time in the marketplace, personal information may be priced at $100 and financial data may be priced at $300, and thus the legal service sector requiring the two may be given a quotation of $350. Additionally, and/or alternatively, the data may be purchased individually rather than in a bundle, without departing from the scope of the disclosure. In an additional embodiment, a user contributing high-resolution image datasets for AI model training may receive a premium valuation if the dataset contains rare, high-quality image annotations, whereas a user contributing transactional purchase history may receive scaled compensation based on the dataset's historical depth, industry relevance, and aggregation level. Similarly, datasets containing biometric health records may receive compensation based on the specificity and granularity of physiological markers, making them highly valuable to precision medicine researchers and biometric security firms.

In an embodiment, the dataset marketplace system 100 may assign individual values to individual data attributes and group values to bundles or groupings of attributes, which often exhibit higher collective value due to their contextual or analytical synergy. The data scoring module 110 may evaluate multi-attribute groupings, using clustering and buyer weightings to determine how the availability and content of grouped attributes enhance predictive power, targeting precision, or modeling reliability for a specific industry use case. For example, the combination of “age,” “gender,” “diagnosis date,” and “zip code” data items may be exponentially more valuable for a pharmaceutical buyer developing population-based risk models than any individual data item field considered in isolation. The quotation table 814 may therefore reflect bundle-level pricing models, where datasets are priced not as the sum of individual parts but based on their holistic readiness and relevance. Such bundle valuations may also be dynamically adjusted using marketplace feedback mechanisms, historical ROI performance, and buyer-supplied scoring templates. In some implementations, the system 100 may highlight recommended bundles with optimized pricing-to-impact ratios, enabling buyers to engage with modular and context-aware datasets that maximize analytic value and transaction efficiency.

In an embodiment, the interfaces 804A-804D may collectively function as part of an integrated data transaction management system, providing a clear, structured, and privacy-protected pathway to participate in data monetization. The interfaces 804A-804D may leverage the data acquisition module 102 to ensure that datasets are captured and processed securely, while the provenance module 106 may ensure that all transactions are validated through trust scores, authenticity checks, and permitted-use verification protocols. The metadata augmentation module 108 may further enrich datasets with watermarks, authorization metadata, and geo-based data permissions, ensuring that dataset transactions adhere to jurisdictional data sovereignty laws and industry compliance requirements. In an embodiment, the interfaces 804A-804D may integrate dynamic feedback loops, where dataset buyers provide real-time insights into dataset utility, predictive accuracy, and model performance improvements, ensuring that sellers can optimize their data-sharing preferences for enhanced monetization outcomes. For instance, an AI company utilizing speech recognition datasets for NLP model training may provide feedback on dataset coverage, phonetic diversity, and dialect variations, allowing sellers to refine their dataset contributions for increased market value. Similarly, a financial institution utilizing transaction datasets for fraud detection models may indicate which behavioral risk patterns are most valuable, ensuring that sellers can curate and structure their datasets for improved buyer engagement. Accordingly, the marketplace creator exchange module 112 may enable a structured, privacy-centric, and financially transparent approach to dataset monetization, ensuring that individuals have full visibility and control over how their datasets are utilized, valued, and compensated within the dataset marketplace ecosystem.

In an embodiment, the dataset marketplace system 100 may implement a two-phase pricing model to manage the valuation of privacy-inclusive data bundles. The two-phase pricing model may enable pricing evolution from early-stage market discovery to later stage informed, data-driven dynamic pricing. In Phase 1, due to the initial absence of sufficient pricing benchmarks for privacy-centric datasets, the system 100 may employ an auction-based mechanism. Buyers may submit bids detailing the types of data they seek, the characteristics or dimensions of interest, and their proposed price offers. The dataset requests may be structured and submitted through the user interface or API channels. In parallel, the marketplace exchange module 112 may proactively surface latent demand by identifying patterns in buyer profiles, industry-specific trends, or aggregated need signals, and recommend potential dataset bundles accordingly. In Phase 2, after a sufficient number of historical transactions have been recorded, the system 100 may implement a dynamic price recommendation engine. Such an engine may be analogous to models used in ride-hailing platforms like InDrive, where a suggested price is algorithmically generated but remains subject to negotiation. The pricing engine may consider factors such as historical user “ask” prices for similar datasets, observed buyer bid patterns, metadata descriptors, and scarcity levels of the dataset (e.g., rare demographics or health conditions), and real-time supply-demand imbalances. The result is a data-driven, context-aware price suggestion, which is presented to both the buyer and the seller as a negotiation anchor point.

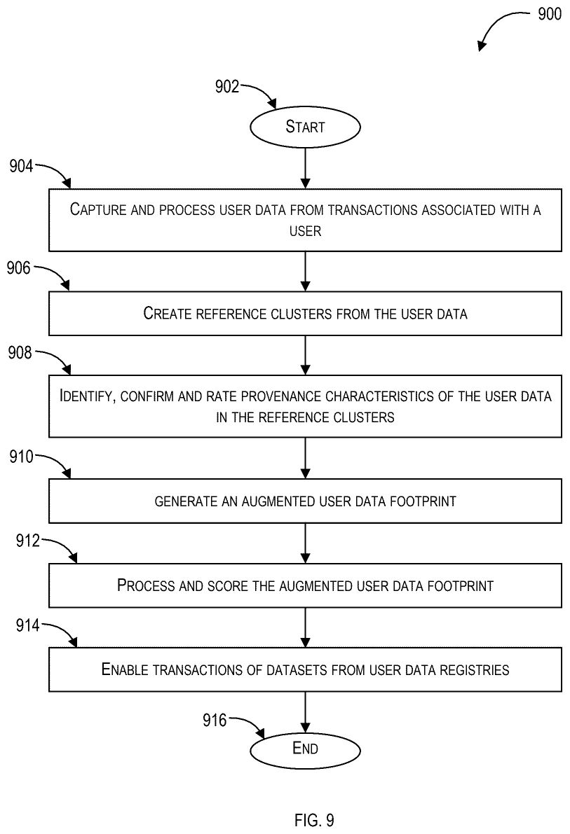

FIG. 9 is a flow chart 900 of an automated dataset marketplace method, in accordance with an embodiment of the present disclosure. The method starts at step 902.

At first, at step 904, the method may include the steps of capturing and processing user data from transactions associated with a user to generate a user data footprint. Further, the method may include ensuring that user data is systematically collected, analyzed, and structured for further processing.

Next, at step 906, the method may include the steps of creating a set of reference clusters from the captured user data. Further, the method may include applying computational techniques to categorize user data into meaningful groups, facilitating improved organization and accessibility of data for industry-specific applications.

Next, at step 908, the method may include the steps of identifying, confirming, and rating provenance characteristics of the user data in the created reference clusters. Further, the method may include ensuring that each dataset undergoes provenance verification, allowing assessment of data authenticity, origin, and reliability before it is processed.

Next, at step 910, the method may include the steps of generating an augmented user data footprint through supplemental user data, which incorporates watermarking and authorization data on a territory basis. Further, the method may include ensuring that datasets contain secure, traceable identifiers that comply with jurisdictional regulations and enable ownership tracking.

Next, at step 912, the method may include the steps of processing the augmented user data footprint, scoring the dataset based on industry-specific parameters and weightings, and generating one or more user data registries on an industry-by-industry basis. Further, the method may include ensuring that datasets are evaluated against sector-specific benchmarks to enhance their usability across different industries.

Thereafter, at step 914, the method may include the steps of enabling transacting of rights in datasets from the one or more user data registries, wherein data suppliers and acquiring entities participate in a secure marketplace. Further, the method may include controlling access to datasets while allowing secure, structured transactions based on industry requirements. In an embodiment, the method may include the steps of collecting user data from one or more sources, wherein the sources may include e-commerce transactions, medical visits, online activity, social interactions, and/or biometric data. In an embodiment, the method may include applying data encryption and anonymization techniques to ensure that collected user data remains secure and privacy-compliant. In an embodiment, the method may include the steps of utilizing machine learning algorithms, including unsupervised clustering and Natural Language Processing (NLP), to create reference clusters from user data. The method may include ensuring that user data attributes are grouped into industry-specific categories. The categories may include healthcare, financial transactions, artificial intelligence, and/or consumer behavior analytics.

In an embodiment, the method may include the steps of assigning a provenance trust score to each dataset by analyzing the origin, authenticity, and verification status of the user data. Further, the method may include blockchain-based verification to maintain data integrity and track the historical usage of the dataset. In an embodiment, the method may include the steps of generating watermarked datasets to uniquely identify data ownership and detect unauthorized distribution. In an embodiment, the method may include embedding territory-based authorizations within the dataset, ensuring jurisdictional compliance with regional regulations governing data transactions. In an embodiment, the method may include the steps of applying Privacy-Inclusive Data Access (PIDA) scoring to evaluate the quality and industry relevance of user datasets. The method may further include adjusting the PIDA score dynamically based on user privacy preferences and industry demand for specific data attributes, ensuring that data valuation remains adaptable to evolving market requirements. The method ends at step 916.

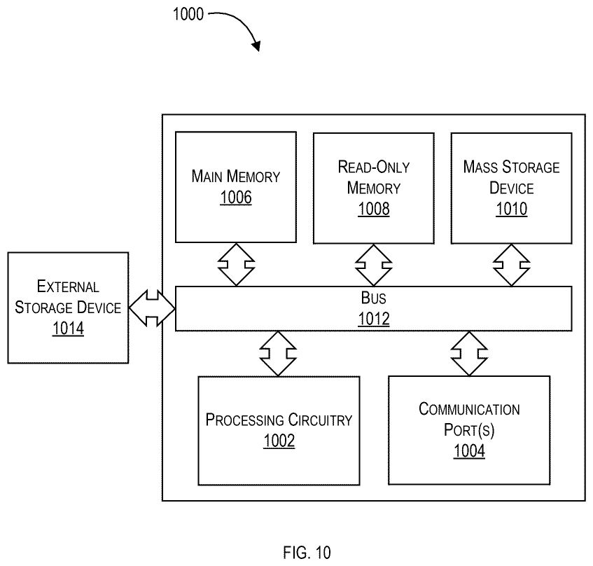

FIG. 10 illustrates an exemplary computer unit 1000 in which or with which embodiments of the present disclosure may be utilized. As shown in FIG. 10, a computer system 1000 includes an external storage device 1014, a bus 1012, a main memory 1006, a read-only memory 1008, a mass storage device 1010, a communication port 1004, and a processor 1002. System 1000 may be implemented as part of a dedicated website server computing system, a cloud computing system, and/or a standalone computing system. In some instances portions of the functional modules identified above may be implemented in whole or part on mobile devices used by the market participants.

Those skilled in the art will appreciate that computer system 1000 may include more than one processor 1002 and communication ports 1004. Examples of processor 1002 include, but are not limited to, an Intel® Itanium® or Itanium 2 processor(s), or AMD® Opteron® or Athlon MP® processor(s), Motorola® lines of processors, FortiSOC™ system on chip processors, or other future processors. The processor 1002 may include various modules associated with embodiments of the present disclosure.

The communication port 1004 can be any of an RS-232 port for use with a modem-based dialup connection, a 10/100 Ethernet port, a Gigabit or 10 Gigabit port using copper or fiber, a serial port, a parallel port, or other existing or future ports. The communication port 1004 may be chosen depending on a network, such as a Local Area Network (LAN), Wide Area Network (WAN), or any network to which the computer system connects.

The memory 1006 can be Random Access Memory (RAM), or any other dynamic storage device commonly known in the art. Read-Only Memory 1008 can be any static storage device(s) e.g., but not limited to, a Programmable Read-Only Memory (PROM) chips for storing static information e.g., start-up or BIOS instructions for processor 1002.

The mass storage 1010 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

The bus 1012 communicatively couples processor(s) 1002 with the other memory, storage, and communication blocks. The bus 1012 can be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processor 1002 to a software system.

Optionally, operator and administrative interfaces, e.g., a display, keyboard, and a cursor control device, may also be coupled to bus 1012 to support direct operator interaction with the computer system. Other operator and administrative interfaces can be provided through network connections connected through communication port 1004. An external storage device 1014 can be any kind of external hard-drives, floppy drives, IOMEGA® Zip Drives, Compact Disc-Read-Only Memory (CD-ROM), Compact Disc-Re-Writable (CD-RW), Digital Video Disk-Read Only Memory (DVD-ROM). The components described above are meant only to exemplify various possibilities. In no way should the aforementioned exemplary computer system limit the scope of the present disclosure.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

Thus, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices can exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art.

What is claimed is:

1. An automated integrated dataset marketplace system comprising:
a data acquisition module to capture and process user data from transactions associated with a user to generate a user data footprint;
a data clustering module adapted to create reference clusters from the captured user data;
a provenance module adapted to identify, confirm, and rate provenance characteristics of the user data in the created reference clusters;
a metadata augmentation module adapted to generate an augmented user data footprint through supplemental user data, including watermark and authorization data on a territory basis;
a data scoring module adapted to process the augmented user data footprint, score the same based on industry-specific parameters and weightings, and generate one or more user data registries on an industry-by-industry basis; and
a marketplace creator exchange module adapted to enable transacting of datasets from the one or more user data registries between users supplying data for said datasets and entities desiring to acquire rights in the same.

2. The system of claim 1, wherein the data acquisition module collects user data from one or more sources, including at least one of: e-commerce transactions, medical visits, online activity, social interactions, and biometric data.

3. The system of claim 2, wherein the data acquisition module applies data encryption and anonymization techniques to ensure user privacy and compliance with regulatory requirements.

4. The system of claim 1, wherein the data clustering module utilizes at least one machine learning algorithm selected from a group consisting of unsupervised clustering and Natural Language Processing (NLP), to create reference clusters from user data.

5. The system of claim 4, wherein the data clustering module groups user data attributes into industry-specific categories including at least one of: healthcare, financial transactions, artificial intelligence, and consumer behavior analytics.

6. The system of claim 1, wherein the provenance module assigns a provenance trust score to each dataset by analyzing the origin, authenticity, and verification status of the user data.

7. The system of claim 6, wherein the provenance module employs blockchain-based verification to ensure data integrity and track the history of user data transactions.

8. The system of claim 1, wherein the metadata augmentation module generates watermarked datasets to uniquely identify data ownership and detect unauthorized distribution.

9. The system of claim 8, wherein the metadata augmentation module embeds territory-based authorizations in the dataset to enforce jurisdictional compliance for data transactions.

10. The system of claim 1, wherein the data scoring module applies Privacy-Inclusive Data Access (PIDA) scoring to evaluate the quality and industry relevance of user datasets based on privacy settings, completeness, and usability.

11. The system of claim 10, wherein the data scoring module adjusts the PIDA score dynamically based on user privacy preferences and industry demand for specific data attributes.

12. The system of claim 1, wherein the marketplace creator exchange module is further configured to:
enable users to define customized privacy charters, allowing them to selectively share data attributes based on industry type and buyer reputation; and
provide automated compensation mechanisms, including smart contracts, tokenized payments, or royalty-based transactions, for users sharing high-value data footprints.

13. The system of claim 1, wherein the marketplace creator exchange module includes compliance verification tools that assess potential data buyers against privacy regulations, industry standards, and ethical AI practices before approving data transactions.

14. The system of claim 1, wherein the marketplace creator exchange module supports multi-party data transactions, allowing multiple buyers to acquire independent associated limited access rights to segmented portions of the dataset based on customized access permissions.

15. An automated integrated dataset marketplace method comprising:
capturing and processing user data from transactions associated with a user to generate a user data footprint;
creating reference clusters from the captured user data;
identifying, confirming, and rating provenance characteristics of the user data in the created reference clusters;
generating an augmented user data footprint through supplemental user data, including watermark and authorization data on a territory basis;
processing the augmented user data footprint, scoring the same based on industry-specific parameters and weightings, and generating one or more user data registries on an industry-by-industry basis; and
enabling transacting of datasets from the one or more user data registries between users supplying data for said datasets and entities desiring to acquire rights to the same.

16. The method of claim 15, further comprises:
collecting user data from one or more sources, including at least one of: e-commerce transactions, medical visits, online activity, social interactions, and biometric data; and
applying data encryption and anonymization techniques to ensure user privacy and compliance with regulatory requirements.

17. The method of claim 15, further comprises:
utilizing machine learning algorithms, including unsupervised clustering and Natural Language Processing (NLP), to create reference clusters from user data; and
grouping user data attributes into industry-specific categories including at least one of: healthcare, financial transactions, artificial intelligence, and consumer behavior analytics.

18. The method of claim 15, further comprises:
assigning a provenance trust score to each dataset by analyzing the origin, authenticity, and verification status of the user data; and
employing blockchain-based verification to ensure data integrity and track the history of user data transactions.

19. The method of claim 15, further comprises:
generating watermarked datasets to uniquely identify data ownership and detect unauthorized distribution; and
embedding territory-based authorizations in the dataset to enforce jurisdictional compliance for data transactions.

20. The method of claim 15, further comprises:
applying Privacy-Inclusive Data Access (PIDA) scoring to evaluate the quality and industry relevance of user datasets based on privacy settings, completeness, and usability; and
adjusting the PIDA score dynamically based on user privacy preferences and industry demand for specific data attributes.
